(19) United States
(12) Patent Application Publication
(10) Pub. No.: US 2024/0086825 A1
(43) Pub. Date: Mar. 14, 2024

(54) SYSTEMS AND METHODS FOR TAGGING AND TRACKING REUSABLE PACKAGING USING ARTIFICIAL INTELLIGENCE TO MAXIMIZE THE USAGE OF A PHYSICAL PRODUCT ACROSS ITS LIFESPAN

(71) Applicant: REUSO, Libertyville, IL (US)

(72) Inventors: Neil Misak, Libertyville, IL (US); Eva Bugg, Libertyville, IL (US)

(21) Appl. No.: 18/367,140

(22) Filed: Sep. 12, 2023

Related U.S. Application Data
(60) Provisional application No. 63/375,382, filed on Sep. 12, 2022.

(51) Int. Cl. G06Q 10/0833

(52) U.S. Cl. CPC G06Q 10/0833

(57) ABSTRACT

Artificial intelligence (AI) based systems and methods are described for tagging and tracking reusable packaging. A system configured to track reusable containers may include a plurality of reusable containers, each reusable container comprising a unique container identifier configured to be read by a scanning device; one or more processors communicatively coupled to the scanning device; computing instructions stored on the one or more memories that, when executed, cause the one or more processors to: receive the unique container identifier of one of the plurality of reusable containers scanned by the scanning device, allocate the unique container identifier to an electronic profile associated with a user, receive the unique container identifier of the one of the plurality of reusable containers after the unique container identifier has been allocated to the electronic profile associated with the user, and/or deallocate the unique container identifier from the electronic profile associated with the user.

### CROSS REFERENCE TO RELATED APPLICATIONS

The present application claims the benefit of U.S. Provisional Patent Application No. 63/375,382, filed on Sep. 12, 2022, which is hereby expressly incorporated by reference herein in its entirety.

### FIELD OF THE INVENTION

The present disclosure generally relates to systems and methods for tagging and tracking reusable packaging, and more particularly to, systems and methods for tagging and tracking reusable packaging using artificial intelligence to maximize the usage of a physical product up across its lifespan.

### BACKGROUND

A food or beverage container is single-use and/or disposable if it is made of a non-recyclable or a non-biodegradable/non-compostable material (e.g., non-durable or flimsy plastics). Since the inception of plastic and other polymers at the dawn of the twentieth century, single-use and/or disposable food and beverage containers drastically increased the shelf life of perishable goods at a very low cost.

However, the widespread adoption of single-use and/or disposable food and beverage containers has had severe, negative effects on the environment. First, single-use and/or disposable food and beverage containers are typically manufactured out of polymers made from fossil fuels (e.g., crude oil). The extraction and processing of these fossil fuels has been shown to be a leading cause of global climate change (as each stage of the creation of these containers generates excessive greenhouse gas emissions). Second, because these containers cannot be recycled, they are typically deposited in designated landfills when properly disposed of. As consumers continue to use and dispose of single-use and/or disposable food and beverage containers, landfills need to expand to accommodate the continual influx of waste which results in an increase in nonarable land at best and an increase in deforestation at worst. Third, when these containers are not properly disposed of—which studies show is quite often—they and end up in either natural biomes or water supplies. The decomposition and degradation of these containers has resulted in (i) the disruption of habitats and ecosystems, (ii) the contamination of soil and groundwater, and (iii) the proliferation of microplastics across all bodies of water and food chains.

For the foregoing reasons, there is a need for systems and methods for tagging and tracking reusable packaging using artificial intelligence to maximize the usage of a physical product up across its lifespan.

### SUMMARY

The disclosed systems and methods assign and track reusable packages from manufacturers to purveyors to customers, which minimizes waste and provides premium, reusable packaging. This can incentivize consumers to return containers to designated areas via SaaS system.

In one example, a system may be configured to track reusable containers comprises a plurality of reusable containers, one or more processors, one or more memories, and computing instructions stored on the one or more memories. Each reusable container comprises a unique container identifier configured to be read by a scanning device. The one or more processors are communicatively coupled to the scanning device and can be one or more processors of a cloud-based/SaaS system such as Microsoft Azure or processor(s) of a server or computer located on-site at the physical sale environment. The one or more memories are accessible by the one or more processors. The computing instructions, when executed, may cause the one or more processors to: receive the unique container identifier of one of the plurality of reusable containers scanned by the scanning device; allocate the unique container identifier to an electronic profile associated with a user; receive the unique container identifier of the one of the plurality of reusable containers after the unique container identifier has been allocated to the electronic profile associated with the user; and/or deallocate the unique container identifier from the electronic profile associated with the user.

In a further example, the reusable containers may comprise at least one of: beverage containers, food containers, and/or product containers.

In a further example, the unique container identifier may be contained in at least one of: a radio frequency identification (RFID) chip, a quick response (QR) code, a barcode, and/or a microtransponder.

In a further example, the microtransponder may comprise a p-Chip.

In a further example, the RFID chips may be attached to the reusable containers.

In a further example, the RFID chips may be molded into the reusable containers.

In a further example, the QR codes may be: printed on a surface of the reusable containers, printed on a label attached to the reusable container, and/or molded into the surface of the reusable containers.

In a further example, the barcodes may be: printed on a surface of the reusable container, printed on a label attached to the reusable container, and/or molded into the surface of the reusable containers.

In a further example, the scanning device may comprise at least one of: an RFID reader, a QR code reader, a barcode reader, and/or a p-Chip reader.

In a further example, the unique container identifiers may be assigned to a platform user.

In a further example, assigning the unique container identifier to the electronic profile associated with the user may comprise associating the container identifier with one or more of: a phone number of the user, a credit card number of the user, and/or an application (app), such as the Major League Baseball (MLB) app, installed on a device of the use.

In a further example, the computing instructions may be configured to track the state of the reusable containers, such as whether they need to be washed/sanitized or not.

In a further example, the computing instructions may be configured to compare the total number of times each of the plurality of reusable containers has been assigned to an electronic profile associated with a user and compare the total number of times to a lifespan of each of the plurality of reusable containers.

In a further example, the computing instructions may receive the unique container identifier of one of the plurality of reusable containers from an intermediate ordering platform, such as GrubHub, MLB, etc.

In a further example, the computing instructions may be configured to track a location where the unique container identifier of one of the plurality of reusable containers is scanned, such as the upper deck, an identified concession stand, an identified vendor, etc.

In a further example, the computing instructions may be configured to determine one or more of: electricity saved, material wasted saved, and/or CO2 saved, based on the number of unique container identifiers assigned and removed from the electronic profiles of associated users.

In a further example, receipt of the unique container identifier of the one of the plurality of reusable containers after the unique container identifier may have been allocated to the electronic profile associated with the user occurs after the one of the plurality of reusable containers has been returned.

In a further example, the computing instructions may be configured to charge an associated user if one of the plurality of reusable containers assigned to the electronic profile of the user is not returned.

In a further example, the computing instructions may be configured to provide a reward to the user, such as a digital punch on a digital punchcard, after one of the plurality of reusable containers assigned to the electronic profile of the user is returned.

In a further example, the computing instructions may be configured to track the number of reusable containers assigned and removed from the electronic profiles of associated users and automatically send an order for additional reusable containers if an inventory of reusable containers is below a predetermined level.

In a further example, a system may comprise: an artificial intelligence (AI) model stored on the one or more memories for outputting a prediction for an event, wherein the AI model may be trained on a plurality of training data selected from: dates or times of events, teams or event participants, standings of the teams or event participants, real-time data associated with events, and/or user data of a plurality of users, and/or wherein the computing instructions, when executed by the one or more processors, may cause the one or more processors to: input, into the AI model, one or more of: a date or time of the event, one or more teams or event participants, standings of one or more teams or event participants, real-time data associated with the event, and/or user data; and/or output, by the AI model, a predicted number of reusable containers expected to be needed for one or more of: the event, one or more intervals during the event, and/or a future time associated with the event or one or more future events.

In another example, a method for tracking reusable containers is disclosed. The method may comprise: receiving, by one or more processors, a unique container identifier of one of a plurality of reusable containers scanned by a scanning device; allocating, by the one or more processors, the unique container identifier to an electronic profile associated with a user; receiving, by the one or more processors, the unique container identifier of the one of the plurality of reusable containers after the unique container identifier has been allocated to the electronic profile associated with the user; and/or deallocating, by the one or more processors, the unique container identifier from the electronic profile associated with the user when the one of the plurality of reusable containers has been returned.

In a further example, the user may comprise a distributor of the plurality of reusable containers, and the above referenced method may further comprise: receiving, by the one or more processors, an initial count of the plurality of reusable containers, the initial count being generated before allocating the unique container identifier to the electronic profile; receiving, by the one or more processors, a subsequent count of the plurality of reusable containers, the subsequent count being generated after deallocating the unique container identifier from the electronic profile; and/or replacing, by the one or more processors, a number of replacement reusable containers, the number based upon a difference between the subsequent count of the plurality of reusable containers and the initial count of the plurality of reusable containers.

In a further example, the user is an individual, and where allocating the unique container identifier to the electronic profile associated with the user comprises: generating, by the one or more processors, a timer of a predetermined time period, wherein the timer halts when the one of the plurality of reusable containers is returned before the timer reaches the predetermined time period and the one of the plurality of reusable containers is automatically deallocated when the timer reaches the predetermined time period, and/or prior to allocating the unique container identifier to the electronic profile associated with the user, the above referenced method may further comprise: transmitting, by the one or more processors, a perishable, one-time code to a client device of the user; and/or receiving, by the one or more processors from a distributor of the plurality of reusable containers; the perishable, one-time code.

In a further example, the above referenced method may further comprise: receiving, by the one or more processors, a flag indicating that the timer has halted; and/or rewarding, by the one or more processors, the electronic profile based upon one or more of: (i) a remainder of the predetermined time period, (ii) a number of previously returned reusable containers, and/or (iii) a number of referred electronic profiles associated with other users, wherein the reward includes one or more of: (i) a free item, (ii) a discount on a future use of a reusable container, and/or (iii) a digital punch on a digital punchcard.

In a further example, prior to deallocating the unique container identifier from the electronic profile associated with the user, the above referenced method may further comprise: receiving, by the one or more processors from the client device, unique bin identifier corresponding to a collection bin housing returned reusable containers.

In a further example, the above referenced method may further comprise: receiving, by the one or more processors, a flag indicating that the timer has reached the predetermined time period; and/or charging, by the one or more processors, the electronic profile a value of the one of the plurality of reusable containers, and/or deducting, by the one or more processors, one from a current total of reusable containers that can be allocated to the electronic profile.

In a further example, a distributor of the plurality of reusable containers collects returned reusable containers housed within a plurality of collection bins and the method may further comprise: receiving, by the one or more processors, capacity data each collection bin of the plurality of collection bins; determining, by the one or more processors, a collection route of the returned reusable containers based upon (i) a set of geographic locations corresponding to each of the plurality of collection bins and (ii) the capacity data; and/or transmitting, by the one or more processors to the distributor, the collection route.

In a further example, determining the collection route of the returned reusable containers may be further based upon: generating, by the one or more processors, input data comprising (i) current day-of-the-week data, (ii) the set of geographic locations, (iii) the capacity data, and (iv) per mile greenhouse gas emissions generated from collecting the reusable containers from collection bins; and/or applying, by the one or more processors, a projected-path machine learning model on the input data to generate the collection route, wherein the projected-path machine learning model may be trained on a set of prior collection route data, the set of prior collection route data including (i) day-of-the-week data, (ii) set of geographic location data of collection bins visited along each prior collection route, (iii) capacity data of the collection bins visited along each prior collection route, and/or (iv) per mile greenhouse gas emissions generated from the prior collection route.

In a further example, the above reference method may further comprise: generating, by the one or more processors, a digital representation of the one of the plurality of reusable containers that includes one or more of: (i) the unique container identifier of one of a plurality of reusable containers, (ii) an allocations counter corresponding to a number of prior allocations to electronic profiles, (iii) a lifespan counter corresponding to a number of days since the one of a plurality of reusable containers was first allocated to an electronic profile up until the one of a plurality of reusable containers is replaced, (iv) geographic location data of collection bins the one of the plurality of reusable containers was previously housed in, and/or (v) date data of when the one of the plurality of reusable containers was previously deallocated.

In a further example, a digital representation of the one of the plurality of reusable containers may include (i) unique container identifiers of the replaced reusable containers, (ii) allocations counters of the replaced reusable containers, and/or (iii) lifespan counters of the replaced reusable containers, and/or the method may further comprise: applying, by the one or more processors, a replacement prediction machine learning model on the digital representation to predict a replacement time of the one of the plurality of reusable containers, wherein the replacement prediction machine learning model may be trained on a training set of digital representations of previously replaced reusable containers, the training set of digital representations including (i) unique container identifiers of the previously replaced reusable containers, (ii) allocations counters of the previously replaced reusable containers, and/or (iii) lifespan counters of the previously replaced reusable containers.

In another example, a tangible, non-transitory computer-readable medium storing instructions for tracking reusable containers is disclosed. The instructions, when executed by one or more processors, may cause the one or more processors to: receive, by one or more processors, a unique container identifier of one of a plurality of reusable containers scanned by a scanning device; allocate, by the one or more processors, the unique container identifier to an electronic profile associated with a user; receive, by the one or more processors, the unique container identifier of the one of the plurality of reusable containers after the unique container identifier has been allocated to the electronic profile associated with the user; and/or deallocate, by the one or more processors, the unique container identifier from the electronic profile associated with the user when the one of the plurality of reusable containers has been returned.

In accordance with the above, and with the disclosure herein, the present disclosure includes improvements in computer functionality and/or in improvements to other technologies. These improvements are due, at least in part, because the disclosures herein describe an increased intelligence and/or predictive ability in application servers and/or computing devices (e.g., host servers and/or client devices) using trained machine learning models (e.g., the replacement prediction machine learning model and/or the projected-path machine learning model described herein). For example, the replacement prediction machine learning model, executing on an application server and/or computing device, may accurately predict when a reusable container needs to be replaced (e.g., a remaining lifespan of the reusable container) based upon data related to previously replaced reusable containers. As another example, the projected-path machine learning model, executing on an application server and/or computing device, may accurately determine a collection route of returned reusable containers that minimizes greenhouse gas emissions as a result of the collection (e.g., from the collections vehicle as it travels along the collection route) based upon previous collection route data.

In addition, the present disclosure describes improvements in the functioning of the computer itself at least because the computing systems and/or the computer devices described herein are made more efficient by the configuration, adjustment, and/or adaptation of a given machine-learning network architecture. For example, in some aspects, fewer machine resources (e.g., processing cycles or memory storage) are used when the computing systems and/or the computer devices utilize machine-learning to analyze and/or process digital twin data. First, the automatic generation, tracking, and/or updating of digital twin data—which acts as a digital representation of a physical object (e.g., the reusable containers)—reduces or eliminates redundant data (e.g., a singular stored digital twin to be referenced and/or pulled as opposed multiple instances of the same or similar data for representing or tracking a given container in multiple, redundant systems). Second the utilization of machine learning on digital twin data results in an efficient and accurate system in calculating lifespans of reusable containers (as opposed to the manual entry of data, trail-and-error computations and/or determinations, etc. across redundant system, as used by conventional database systems, for tracking containers). Such implementations free up the computational resources of an underlying computing system, thereby making the computing systems and/or the computer devices described more efficient.

Additionally, the present disclosure describes improvements in the functioning any other technology or technical field because computing systems and/or computing devices are enhanced by leveraging the plurality of historical data to accurately predict, detect, and/or otherwise determine (i) replacement times of reusable container needs and/or (ii) projected collection routes that minimize greenhouse gas emissions. These enhancements improve upon conventional techniques at least because existing systems lack such predictive or classification functionality. In particular, conventional techniques typically result in the generation of waste products (e.g., other reusable containers are often thrown away into landfills due to a lack of a collection system) and/or an increase in greenhouse gas emissions due to the efforts to collect and redistribute them (e.g., systems that do collect and/or recycle food and beverage containers do not utilize the predictive capabilities of AI to determine routes that minimize greenhouse gas emissions from collection vehicles).

Also, the underlying system is an improvement in the field of environmental conservationism. Not only do the methods and systems described herein call for reusable (and/or recyclable, biodegradable, and/or compostable) materials, but the AI methods and systems described herein are designed to (i) maximize the lifespan of these reusable containers—thereby reducing waste to be sent to landfills and/or ending up in natural habitats/ecosystems—and (ii) minimize the effects of greenhouse gas emissions during the lifespan of these reusable containers.

In addition, in some aspects, the present disclosure describes the application of certain claim elements with, or by use of, a particular machine. For example, in some aspects, the present disclosure details the use of reusable containers comprising microchips and/or microtransponders (such as p-Chips) to be the unique container identifiers of the reusable containers.

Further, in some aspects, the present disclosure describes specific features other than what is well-understood, routine, conventional activity in the field, and/or describes additional unconventional steps that confine the claims to a particular useful application. For example, the systems and methods for tagging and tracking reusable packaging using artificial intelligence maximize the usage of a physical products across its lifespan (e.g., by using the replacement prediction machine learning model to predict a replacement time of the reusable packaging).

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts a particular aspect of the disclosed system and methods, and that each of the Figures is intended to accord with a possible aspect thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present aspects are not limited to the precise arrangements and instrumentalities shown, wherein:

FIG. 1 illustrates an example computer system configured to track reusable containers, in accordance with various aspects disclosed herein.

FIG. 2 illustrates an example machine learning training module, in accordance with various aspects disclosed herein.

FIG. 3 illustrates an example method for tracking reusable containers, in accordance with various aspects disclosed herein.

FIG. 4 illustrates example reusable containers, in accordance with various aspects disclosed herein.

FIG. 5 illustrates example unique container identifiers, in accordance with various aspects disclosed herein.

FIG. 6A illustrates a block diagram representative of an example flowchart of checking-out a reusable container, in accordance with various aspects disclosed herein.

FIG. 6B illustrates a block diagram representative of an example flowchart of checking-in a reusable container, in accordance with various aspects disclosed herein.

FIG. 7 illustrates an example individual facing graphical user interface for user sign up as rendered on a display screen of a computing device, in accordance with various aspects disclosed herein.

FIG. 8A illustrates an example individual facing graphical user interface for checking-out a reusable container as rendered on a display screen of a computing device, in accordance with various aspects disclosed herein.

FIG. 8B illustrates an example individual facing graphical user interface for checking-out a reusable container as rendered on a display screen of a computing device, in accordance with various aspects disclosed herein.

FIG. 9 illustrates an example distributor facing graphical user interface for checking-out a reusable container as rendered on a display screen of a computing device, in accordance with various aspects disclosed herein.

FIG. 10A illustrates an example individual facing graphical user interface for checking-in a reusable container as rendered on a display screen of a computing device, in accordance with various aspects disclosed herein.

FIG. 10B illustrates a further example individual facing graphical user interface for checking-in a reusable container as rendered on a display screen of a computing device, in accordance with various aspects disclosed herein.

FIG. 11A illustrates an example distributor facing graphical user interface for checking-in a reusable container as rendered on a display screen of a computing device, in accordance with various aspects disclosed herein.

FIG. 11B illustrates a further example distributor facing graphical user interface for checking-in a reusable container as rendered on a display screen of a computing device, in accordance with various aspects disclosed herein.

FIG. 12A illustrates an example individual facing graphical user interface for ordering a reusable container as rendered on a display screen of a computing device, in accordance with various aspects disclosed herein.

FIG. 12B illustrates a further example individual facing graphical user interface for ordering a reusable container as rendered on a display screen of a computing device, in accordance with various aspects disclosed herein.

The Figures depict preferred aspects for purposes of illustration only. Alternative aspects of the systems and methods illustrated herein may be employed without departing from the principles of the invention described herein

### DETAILED DESCRIPTION

### Exemplary Computer System

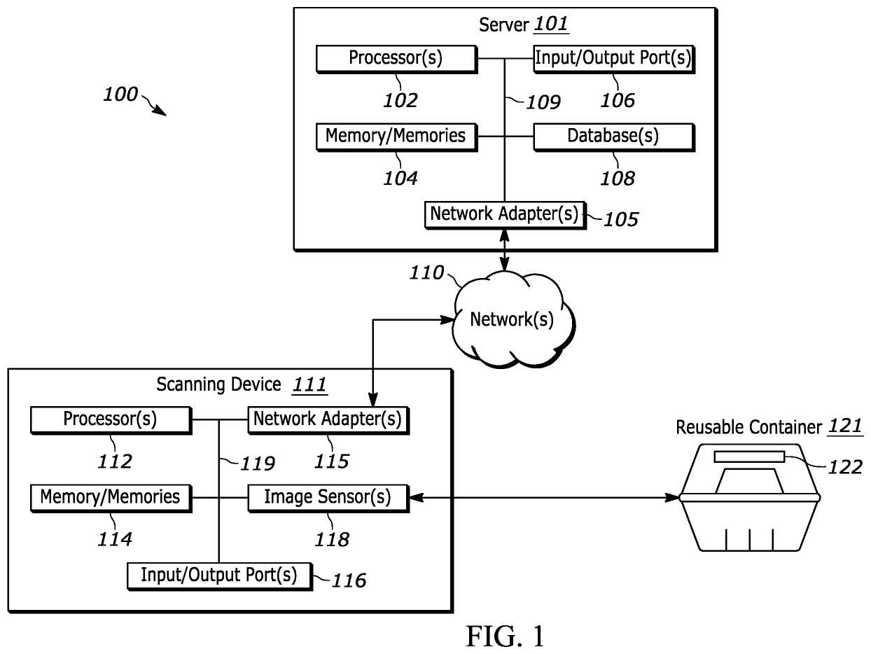

FIG. 1 depicts an exemplary computer system 100 for the implementation of the methods and systems described herein. The computer system 100 may include server(s) 101 scanning device(s) 111, reusable container(s) 121, and/or communication network(s) 110.

The server(s) 101, may comprise one or more computer servers. In various aspects, the server(s) 101 may comprise multiple servers, which in turn may comprise multiple, redundant, and/or replicated servers as part of a server farm. In still further aspects, the server(s) 101 may be implemented as cloud-based servers, such as a cloud-based computing platform. The server(s) 101 may include one or more processors 102, one or more computer memories 104, one or more network adapters 105, one or more input/output (I/O) ports 106, and/or one or more databases 108. Any of these components may be communicatively coupled via a communications bus 109.

The scanning device(s) 111, may be any dedicated scanning device (such as an RFID reader, a QR code reader, a barcode reader, a p-Chip reader, and/or the like) or a general computing device capable of scanning (such as a desktop computing device, a laptop computer, a tablet, a mobile device, a smartphone or other smart device, a wearable device, smart contacts, smart glasses, headsets, etc.). In various aspects, the scanning device(s) 111 may comprise multiple devices, which in turn may be communicatively interconnected via one or more wired and/or wireless connections. For example, a scanning device 111 may be a dedicated bar-code scanner connected to a desktop computer. The scanning device(s) 111 may include one or more processors 112, one or more computer memories 114, one or more network adapters 115, one or more input/output (I/O) ports 116, and/or one or more image sensors 118. Any of these components may be communicatively coupled via a communications bus 119.

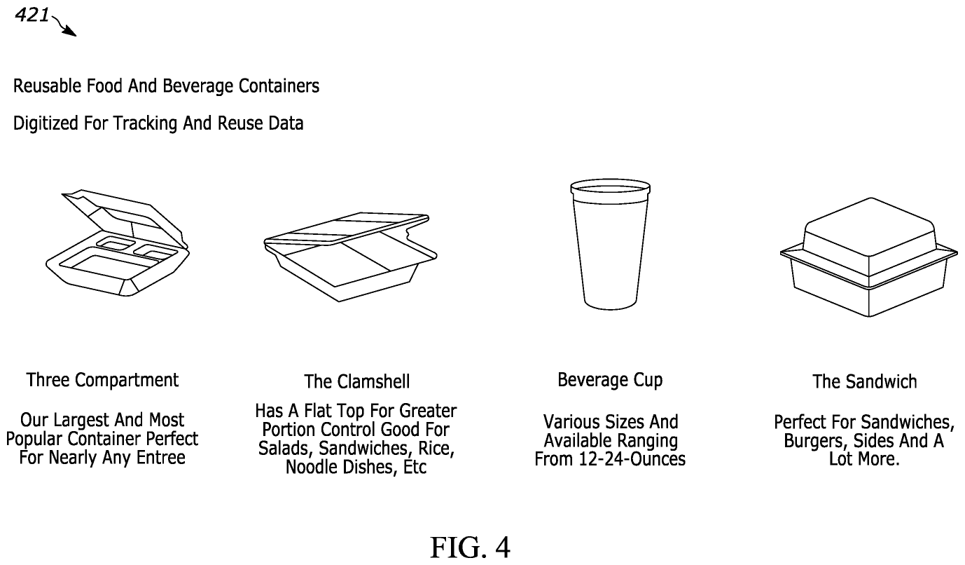

The reusable container(s) 121, may be any reusable container for the packaging, transportation, and consumption of perishable goods. The reusable container(s) 121 may have a form factor of any commonly used food and/or beverage container (such as the reusable container(s) 421 illustrated in FIG. 4). In various aspects, the reusable container(s) 121 are made of recyclable materials (such as durable plastics or other durable polymers). In still further aspects, the reusable container(s) 121 are made of biodegradable and/or compostable materials. In some aspects, the reusable container(s) 121 may include a unique container identifier 122.

The one or more processors 102 of the server(s) 101 and/or the one or more processors 112 of the scanning device(s) 111 may include one or more central processing units (CPUs), one or more coprocessors, one or more microprocessors, one or more graphical processing units (GPUs), one or more digital signal processors (DSPs), one or more application specific integrated circuits (ASICs), one or more programmable logic devices (PLDs), one or more field-programmable gate arrays (FPGAs), one or more field-programmable logic devices (FPLDs), one or more microcontroller units (MCUs), one or more hardware accelerators, one or more special-purpose computer chips, and one or more system-on-a-chip (SoC) devices, etc.

The one or more memories 104 of the server(s) 101 and/or the one or more processors 114 of the scanning device(s) 111 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, solid state drives, flash memory, MicroSD cards, and others. The one or more memories 104 of the server(s) 101 and/or the one or more processors 114 of the scanning device(s) 111 may store an operating system (OS) (e.g., Microsoft Windows, Linux, UNIX, etc.) capable of facilitating the functionalities, apps, methods, or other software as discussed herein. In addition, the one or more memories 104 of the server(s) 101 and/or the one or more processors 114 of the scanning device(s) 111 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, and/or described for the various flowcharts, illustrations, diagrams, figures, and/or other disclosure herein. For example, the one or more memories 104 of the server(s) 101 may include and/or store application(s), software component(s), and/or APIs for the execution of one or more trained machine learning models. It should be appreciated that the stored machine readable instructions may executed by the one or more processor(s) 102 of the server(s) and/or the one or more processors 112 of the scanning device(s) 111.

The one or more network adapters 105 of the server(s) 101 and/or the one or more network adapters 115 of the scanning devices 111 may include be one or more communication components configured to communicate (e.g., send and receive) data via one or more external/network port(s) to the one or more communication networks 110. For example, the one or more network adapters 105 server(s) 101 and/or the one or more network adapters 115 of the scanning devices 111 may be, or may include, a wired network adapter, connector, interface, etc. (e.g., an Ethernet network connector, an asynchronous transfer mode (ATM) network connector, a digital subscriber line (DSL) modem, a cable modem) and/or a wireless network adapter, connector, interface, etc. (e.g., a Wi-Fi connector, a Bluetooth® connector, an infrared connector, a cellular connector, etc.) configured to communicate over the communication networks 110. Additionally or alternatively, in various aspects, the one or more network adapters 105 server(s) 101 and/or the one or more network adapters 115 of the scanning devices 111 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to the one or more communication networks 110.

The one or more I/O ports 106 of the server(s) 101 and/or the one or more I/O ports 116 of the scanning device(s) 111 may include any number of different types of input units or output units, input circuits or output circuits, and/or input components or output components that enable the one or more processors 102 of the server(s) 101 and/or the one or more processors of the scanning device(s) 111 to communicate with one or more input devices and/or one or more output devices. In some aspects, the one or more I/O ports 106 of the server(s) 101 and/or the one or more I/O ports 116 of the scanning device(s) 111 may be combined I/O units, I/O circuits, and/or I/O components. The one or more input devices may include keyboard(s) and/or keypad(s), interactive screen(s) (e.g., touch screens), navigation device(s) (e.g., a mouse, a trackball, a capacitive touch pad, a joystick, etc.), microphone(s), button(s), communication interface(s), etc. The one or more output devices may include display unit(s) (e.g., display screens, printers, etc.), speaker(s), etc.

The one or more databases 108 of the server(s) 101 may include one or more data repositories and/or the like. For example, the one or more databases 108 may store training data used to train a machine learning model described herein. Additionally or alternatively, the one or more databases 101 may store one or more trained machine learning models, which in turn may be accessible or otherwise communicatively coupled to the one or more processors 102 of the server(s) 101.

The one or more image sensors 118 of the scanning device(s) 111 may include any image capturing device(s), unit(s), component(s), and/or sensor capable(s) of capturing image data. For example, the image sensors 118 may be CMOS image sensors, CCD image sensors, and/or other types of image sensor architectures. The image sensors 118 may be configured to capture convert the values of the component sensors into a file format associated with image data.

The communications bus 109 of the server(s) 101 and/or the communications bus 119 of the scanning device 111 may include any dedicated or general-purpose communication bus implementing a bus access protocol that facilitates the communications between the various components of the server(s) 101 or the scanning device(s) 111, respectively.

The one or more communication networks 110 may comprise the internet, a local area network (LAN), a metropolitan area network (MAN), a wide area network (WAN), a wired network, a Wi-Fi network, a cellular network, a wireless network, a private network, a virtual private network, etc.

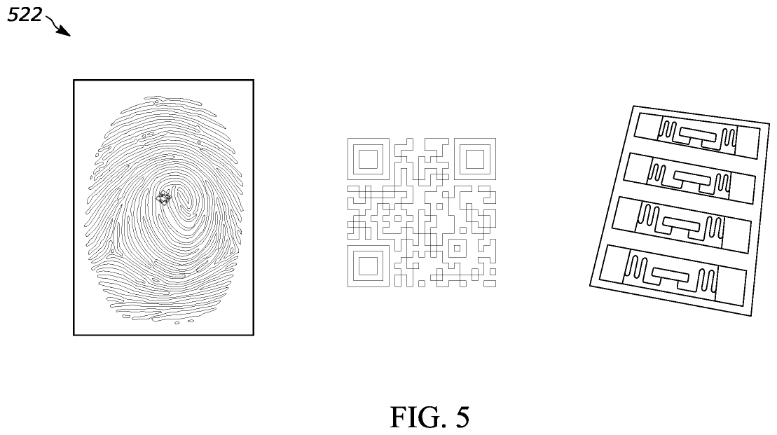

The unique container identifier 122 may include any physical encryption or code such as a radio frequency identification (RFID) chip, a quick response (QR) code, a barcode, and/or a microtransponder (e.g., a p-Chip) such as the unique container identifiers 522 as illustrated in FIG. 5. In some aspects, the unique container identifier 122 may be printed on a surface of the reusable container(s) 121, printed on labels attached to the reusable container(s) 121, and/or molded into the surfaces of the reusable container(s) 121 (e.g., via laser etching, injection molding, etc.). In some aspects, the unique container identifier 122 may also include an unencrypted and human readable string of letters and numbers corresponding to the physical encryption or code.

In some aspects, the server(s) 101 may include a client-server platform technology such as ASP.NET, Java J2EE, Ruby on Rails, Node.js, and/or a web service or online API, responsive for receiving and responding to electronic requests. The server(s) 101 may implement the client-server platform technology that may interact, via the communication bus 109, with the one or more memories 104 (including the applications(s), component(s), API(s), data, etc. stored therein) and/or one or more databases 108 to implement or perform the machine readable instructions, methods, processes, elements or limitations, as illustrated, depicted, or described for the various flowcharts, illustrations, diagrams, figures, and/or other disclosure herein.

As described herein, in some aspects, the server(s) 101 may perform the functionalities as discussed herein as part of a cloud network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, and/or the like) having such computer-readable program code or computer instructions embodied therein, wherein the computer-readable program code or computer instructions may be installed on or otherwise adapted to be executed by the one or more processors 102 of the server(s) 101 and/or the one or more processors 112 of the scanning device(s) 111 (e.g., working in connection with the respective operating system in the one or more memories 104 of the server(s) 101 or the one or more memories 114 of the scanning device(s) 111) to facilitate, implement, and/or perform the machine readable instructions, methods, processes, elements or limitations, as illustrated, depicted, and/or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

In operation, the server(s) 101 may establish a communicative connection with the scanning device(s) 111 via the one or more communication networks 110. In some aspects, establishing the connection may include a user of the scanning device(s) 111 and/or accessing an electronic profile stored with the server(s) 101. In some aspects, establishing the connection may include navigating to a webpage of a website and/or a digital application hosted by the server(s) 101. In these aspects, the scanning device(s) 111, as a client, may establish a client-host connection to the server(s) 101, as a host. Additionally or alternatively, the scanning device(s) 111 may establish the client-host connection via an application run on the scanning device(s) 111. In some aspects, the connection may be through either a third-party connection (e.g., an email server) or a direct peer-to-peer (P2P) connection/transmission.

As noted above, the server(s) 101 may store, train, validate, develop, deploy, and/or otherwise apply one or more machine learning models. Additionally, as also noted above, the server(s) may be multiple servers. In some aspects, the server(s) 101 that train, validate, and/or develop machine learning model(s) (e.g., training server(s)) may be separate and/or distinct from the server(s) 101 that store, deploy, and/or otherwise apply the developed machine learning model(s) (e.g., application server(s)). Alternatively, in some aspects, the training server(s) are the same servers as the application server(s).

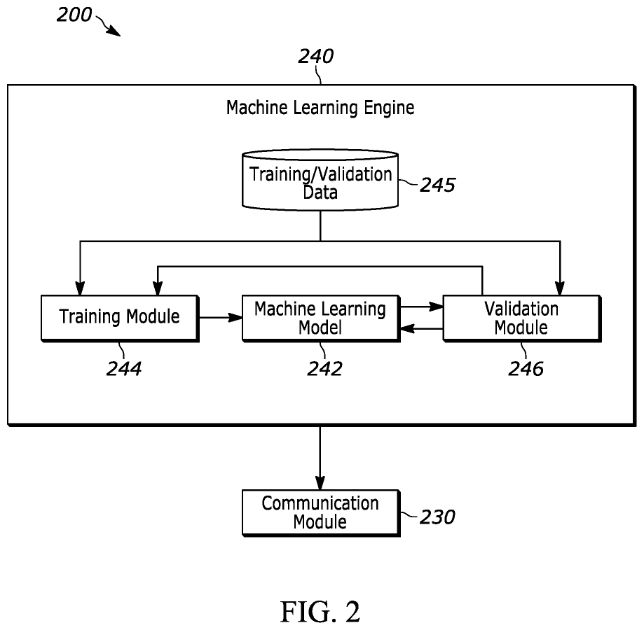

The application servers may route one or more sets of input data received over the one or more communication networks 110 to a communication module (e.g., the communication module 230 as illustrated in FIG. 2). The communication module may forward the one or more sets of input data to pretrained machine learning model (e.g., the machine learning model 242 as illustrated in FIG. 2), which may output a determination. The resulting determination may be returned to the communication module which may in turn present the resulting determination to the user via the scanning device(s) 111.

The training server(s) may train, validate, and/or otherwise develop machine learning model(s), e.g., based upon one or more sets of training data. In some aspects, the resulting machine learning model(s) may be classification models, such as a CNN, a logistic regression model, a naïve Bayes model, a support vector machine (SVM) model, and/or the like. Alternatively, in some aspects, the training server(s) may develop machine learning model(s), e.g., by finding meaningful relationships in unorganized data.

In some aspects, once the training server(s) initially train and/or initially develop the machine learning model(s), the training server(s) may then validate the machine learning model(s). In some aspects, the training server(s) may segment out a set of validation data from the corpus of training data to use when validating model performance. In these aspects, the training data is divided into a ratio of training data and validation data (e.g., 80% training data and 20% validation data). When the machine learning model(s) are applied to the validation data, if the machine learning model(s) satisfy validation metric(s) (e.g., accuracy, recall, area under curve (AUC), etc.) the machine learning model(s) may be implemented as pretrained machine learning model(s) to be used by the application server(s). However, if the machine learning model(s) do not satisfy validation metric(s), the training server(s) may continue training the machine learning model(s) using additional training data.

In some aspects, the communication module may implement interactive user interface(s) (UIs) (e.g., a web-based interface, mobile application, command prompts, etc.) that may be presented by the scanning device(s) 111. In particular, the interactive UIs may be configured to enable the user to submit input data to the server(s) 101.

It should be appreciated that while specific elements, processes, devices, and/or components are described as part of the server(s) 101 and/or scanning device(s) 111, other elements, processes, devices and/or components are contemplated.

### Machine Learning Aspects

In various aspects, the systems, methods, and/or techniques discussed herein may use machine learning (ML) (also known as artificial intelligence (AI)) techniques. For instance, a processor and/or a processing element (e.g., the one or more processors 102 of the server(s) 101 and/or the one or more processors 112 of the scanning device(s) 111) may be trained, validated, and/or otherwise developed using supervised machine learning, unsupervised machine learning, or semi-supervised machine learning. Further, the ML program may employ an artificial neural network, which may be a convolutional neural network (CNN), a fully convolutional neural network (FCN), a deep learning neural network, and/or a combined learning module or program that learns in two or more fields or areas of interest.

Machine learning may involve identifying and/or recognizing patterns in existing data in order to facilitate making predictions, estimates, and/or recommendations for subsequent data. ML models may be trained upon inputs (e.g., training data such as the data of a digital twin of a reusable container as described herein) in order to generate predictions and/or classification (e.g., a prediction of an end-of-life or end-of-serviceable use for a given reusable consider).

ML models may also be either static and/or dynamic. In a static model, the runtime/inference inputs remain unchanged and are the same as the training inputs used to train and/or validate the model. In a dynamic model, however, the runtime/inference inputs may change over time from the initial training data (also referred to as seed data).

In some aspects, the ML programs may be trained and/or validated using labeled training data sets. The ML programs may utilize deep learning algorithms that may be primarily focused on pattern recognition and may be trained after processing multiple examples.

In supervised ML, a processing element identifies patterns in existing data to make predictions and/or classifications about subsequently received data. Specifically, the processing element is trained using training data, which includes example inputs, which may include independent aspects (e.g., features) and associated dependent aspects (e.g., labels). The training data is formatted so that the independent aspects (e.g., features) explain or otherwise statistically correlate to the dependent aspect (e.g., label), such that an ML model outputs a prediction or classification corresponding to the dependent aspect (e.g., label). Based upon the training data, the processing element may generate a predictive function which maps outputs to inputs and may utilize the predictive function to generate outputs based upon data inputs. In this way, the applied ML program, algorithm, and/or technique may determine and/or discover rules, relationships, and/or patterns between the exemplary inputs and the exemplary outputs. The exemplary inputs and exemplary outputs of the training data may include any of the data inputs or outputs described herein. In some aspects, the processing element may be trained by providing it with a large sample of data with known characteristics or features. For example, as used herein, the featured data may include any of the data defining a digital twin of a reusable container as described herein. The labelled data may include a useful-life or end-of-life value as mapped to the feature data of respective digital twin data of one or more reusable containers. In such aspects, the digital twin data may be used to train an ML model to predict or classify a useful-life and/or an end-of-life value of one or more in-use reusable containers, e.g., reusable containers that are currently being used by the system.

In unsupervised ML, the processing element finds meaningful relationships in unorganized data. Unlike supervised learning, unsupervised learning does not involve training based upon example inputs with associated outputs. Rather, in unsupervised learning, the processing element may organize unlabeled data according to a relationship determined by at least one ML method/algorithm employed by the processing element. Unorganized data may include any combination of data inputs and/or outputs as described herein. In an example, a ML model may be trained to classify whether one or more in-use reusable containers have reached an end-life or is otherwise suitable for continued use. In such aspects, such classifications may be used to determine whether the one or more reusable containers should remain in the system or not.

Supervised ML and unsupervised ML may also comprise retraining, relearning, and/or otherwise updating models with new, or different, information, which may include information received, ingested, generated, or otherwise used over time. The disclosures herein may use any of the above-described machine learning techniques.

FIG. 2 depicts a diagram of an exemplary machine learning training module 300. The machine learning training module 200 may include a machine learning engine 240 and/or a communication module 230.

The machine learning engine 240 may include training and/or validation data 245, a training module 244 and/or a validation module 246. The machine learning engine 240 may include a portion of a memory unit (e.g., the one or more memories 102 and/or the one or more database(s) 105 of the server(s) 101) configured to store software and/or computer-executable instructions that, when executed by a processing unit (e.g., the one or more processors 102 of the server(s) 101), may cause the one or more of the above-described components to generate, develop, train, validate, and/or deploy one or more machine learning models 242 (e.g., to predict the remaining lifespan of a reusable container). Once trained and validated, the one or more machine learning models 242 may be deployed or otherwise implemented to perform the methods, systems, or otherwise algorithms described herein.

The training and/or validation data 245 may include labelled data (e.g., reusable containers with a lifespan of less than a year, reusable containers with a lifespan of 1-2 years, reusable containers with a lifespan of 2+ years, etc.) comprising one or more features (e.g., the number of checkouts of each reusable container, the dates and locations of each checkout of the reusable containers, the dates and locations of each return of the reusable containers). The machine learning engine 240 may pass the training and/or validation data 240 to the training module 244 and/or the validation module 246. In some aspects, the machine learning engine 240 segments out a portion of the training data to be a validation set. For example, the machine learning engine 240 may segment out 20%, 10%, 5%, etc., of the training data for the validation data set.

The training module 244 may utilize one or more machine learning programs, algorithms, and/or techniques to train the one or more machine learning models 242. In some aspects, the one or more machine learning models 242 are a CNN, a FCN, or another type of neural network. Accordingly, the training process may include analyzing the labels applied to the training data to determine a plurality of weights associated with the various layers of the neural network.

The validation module 246 may validate the resulting one or more machine learning models 242 by determining a validation metric rate (e.g., accuracy, precision, recall, etc.) of the one or more machine learning models 242. If the validation metric of the one or more machine learning models 242 does not meet a predetermined threshold value, the validation module 246 may instruct the training module 244 to continue training the one or more machine learning models 242 until the one or more machine learning models 242 satisfies the validation metric.

Once the one or more machine learning models 242 satisfies the validation metric, the machine learning engine 240 may pass the resulting one or more machine learning models 242 to a communication module 230 which may then allow the one or more machine learning models 242 to be accessed by one or more remote servers.

The one or more machine learning models 242 may be developed, trained, and/or validated from multiple, parallel machine learning engines 240. It should be appreciated that while specific elements, processes, devices, and/or components are described as part of example machine learning training module 200, other elements, processes, devices and/or components are contemplated and/or the elements, processes, devices, and/or components may interact in different ways and/or in differing orders, etc. For example, in aspects that utilize unsupervised machine learning, the machine learning engine 240 may have a pattern detection module (not shown)—instead of a training module 244 and a validation module 246—to implement one or more unsupervised machine learning programs, algorithms, and/or techniques (e.g., clustering methods such as k-means clustering) on the training data.

In some aspects, the machine learning engine 240 may be utilized to train, validate, and/or otherwise deploy a projected-path machine learning model for the generation of collection routes of reusable containers returned at various collection bins. In these aspects, the projected-path machine learning model may be trained and/or validated on prior collection route data. The prior collection route data may including data relating to previous collection routes, such as: (i) day-of-the-week data (e.g., which day did a previous collection route take place on), (ii) a list of geographic locations of the collection bins visited along the previous collection routes, (iii) capacity data of the collection bins visited along the previous collection routes, and (iv) per mile greenhouse gas emissions generated from the previous collection routes.

By analyzing the various aspects of previous collection route data, the projected-path machine learning model is configured to generate and/or select a collection route that minimizes the emission of greenhouse gas emissions as a result of the collection of the reusable containers. In some aspects, projected-path machine learning model may generate one or more collection routes each comprising one or more confidence scores regarding (i) the likelihood that the collection bins in the generated collection route will meet a threshold minimum capacity of returned reusable containers, (ii) the likelihood that the generated collection route has the most direct distance between the determined collection bins along the generated collection route, and/or (iii) the likelihood that a particular collection route is produces the lowest amount of greenhouse gas emissions. In some aspects, a collection route is then selected based upon the one or more confidence scores with the selected collection route having the greatest value among the one or more confidence scores.

When the pool of prior collection route data is low (e.g., a closed model, such as a university, has only recently adopted collection bins for the return of reusable containers and so it does not have much historical data to rely on for an accurate model), the server(s) 101 may initially determine routes based on manual observation and/or estimations of capacity levels of each of the collection bins and/or naïve algorithms. For example, faculty of a university reports that collection bins A, C, and E become full and/or semi-full by Sunday of each week, but collection bins B and D only become full and/or semi-full by Sunday of every two weeks. Thus, alternating weeks, the server(s) 101 determine a round-trip route based on the Manhattan distance between each of the full and/or semi-full bins in a manner that reduces backtracking (e.g., the collection vehicle travels the optimized Manhattan distances between collection bins A, C, and E on week 1, the optimized Manhattan distances between collection bins A, B, C, D, and E on week 2, and so on until the reported observations and/or naïve algorithms produce a different outcome).

In some aspects, the machine learning engine 240 may be utilized to train, validate, and/or otherwise deploy a replacement prediction machine learning model to predict the replacement time of a reusable container. In these aspects, the replacement prediction machine learning model may be trained and/or validated on digital twin data of previously replaced reusable containers. When a reusable container is manufactured, affixed with a unique container identifier, and/or has been allocated to an electronic profile for the first time, the server(s) 101 may generate digital twin data of the reusable container. The digital twin data may comprise a digital representation of the reusable container and may include, by way of non-limiting example: (i) the unique container identifier of the reusable container, (ii) the number of times the reusable container has been previously allocated, (iii) a lifespan of the reusable container corresponding to the length of time since the reusable container has been (a) manufactured, (b) affixed with its unique container identifier, and/or (c) has been allocated to an electronic profile for the first time up until the reusable container was replaced, (iv) geographic location data of collection bins the reusable container has been previously returned to, and/or (v) date data corresponding to the dates the reusable container has been previously returned.

By analyzing the various aspects of previously replaced reusable containers, the replacement prediction machine learning model is configured to generate a prediction for a remaining lifespan of a currently in use reusable container. In some aspects, the prediction may comprise one or more comparisons between the digital twin data of an in-use container and the respective digital twin data of previously used containers upon which the machine learning model was trained. In some aspects, the prediction is then derived by similarity scores assigned to the various comparisons with the prediction being based upon the comparison with the highest similarity score.

### Exemplary Method

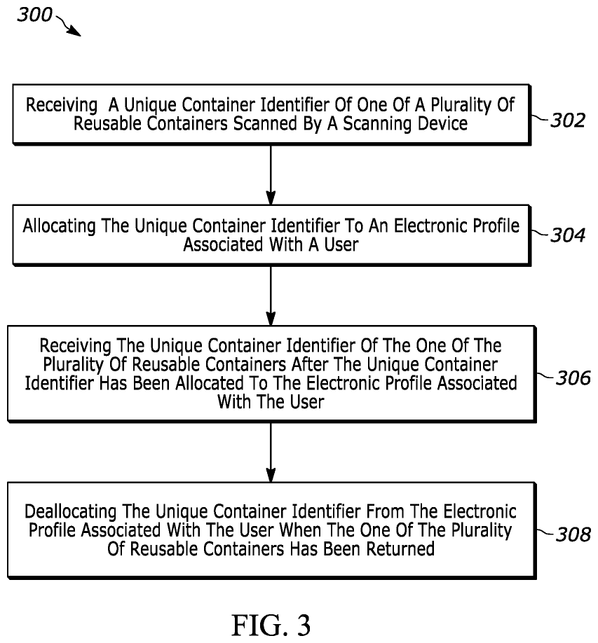

The systems described herein may include one or more computers that may be configured to perform particular operations or actions by virtue of having software, firmware, hardware, or a combination of them installed on the system that in operation causes or cause the system to perform the actions, e.g., for tracking reusable containers. For example, in various aspects one or more computer programs (e.g., as described for FIG. 1 herein) may be configured to perform particular operations or actions by virtue of including instructions that, when executed by data processing apparatus, cause the apparatus to perform the actions. FIG. 3 depicts one aspect, a method 300 that comprises, at block 302, receiving, by one or more processors, a unique container identifier of one of a plurality of reusable containers scanned by a scanning device. At block 304, method 300 further comprises allocating, by the one or more processors, the unique container identifier to an electronic profile associated with a user. At block 306, method 300 further comprises receiving, by the one or more processors, the unique container identifier of the one of the plurality of reusable containers after the unique container identifier has been allocated to the electronic profile associated with the user. At block 308, method 300 further comprises deallocating, by the one or more processors, the unique container identifier from the electronic profile associated with the user when the one of the plurality of reusable containers has been returned. Other aspects of this aspect include corresponding computer systems, apparatus, and computer programs recorded on one or more computer storage devices, each configured to perform the actions of the methods.

### Exemplary Implementations

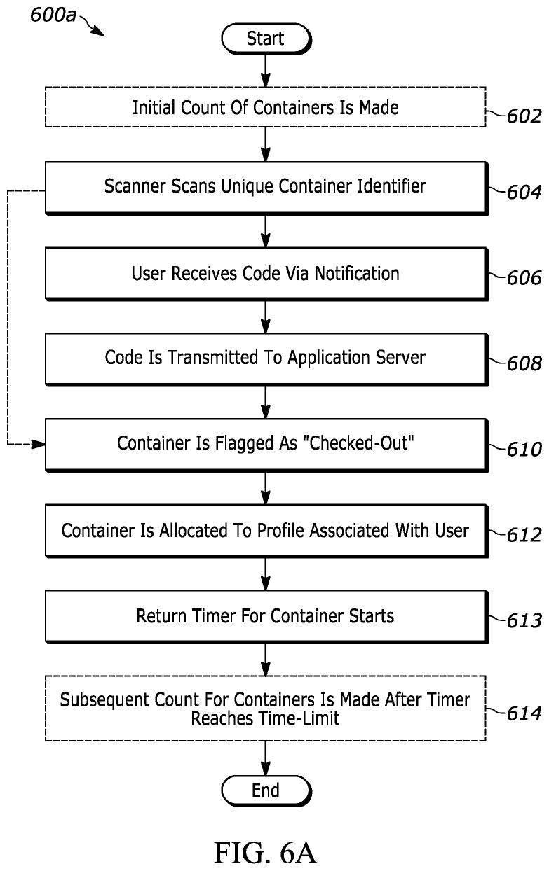

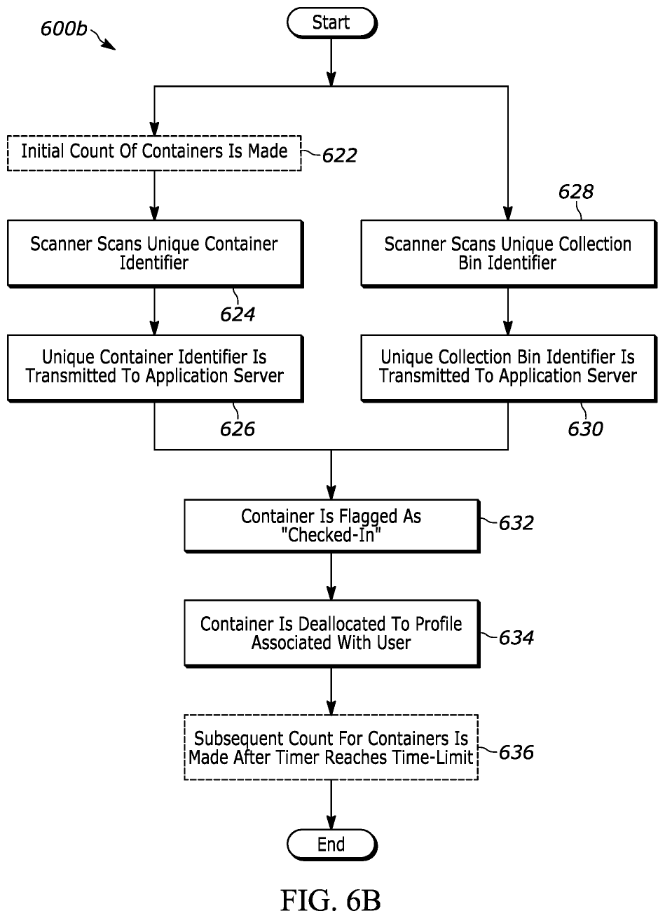

FIG. 6A illustrates a block diagram representative of an example flowchart of checking-out a reusable container, in accordance with various aspects disclosed herein. Similarly, FIG. 6B illustrates a block diagram representative of an example flowchart of checking-in a reusable container, in accordance with various aspects disclosed herein. The example flowcharts of FIGS. 6A and 6B are example processing platform 600a and example processing platform 600a, respectively, capable of executing instructions to, for example, implement operations of the example methods described herein, as may be represented by the flowcharts of the drawings that accompany this description. Other example flowcharts capable of, for example, implementing operations of the example methods described herein include field programmable gate arrays (FPGAs) and application specific integrated circuits (ASICs).

The example processing platform 600a of FIG. 6A and the example processing platform 600b of FIG. 6B may be implemented by the one or more processors 102 of the server(s) 101 and/or the one or more processors 112 of the scanning device(s) 111. The one or more processors 102 and/or the one or more processors 112 may include one or more registers capable of temporarily storing data, and the one or more processors 102 and/or the one or more processors 112 may include further storage capacity in the form of integrated memory slots. The one or more processors 102 may be communicatively coupled to the one or more memories 104 and/or the one or more processors 112 may be communicatively coupled to the one or more memories 114. The one or more processors 102 and/or the one or more processors 112 may interact with the any of the forgoing (e.g., registers, integrated memory slots, one or more memories 104, one or more memories 114) to obtain, for example, machine-readable instructions corresponding to, for example, the operations represented by the flowcharts of this disclosure.

In some aspects, the example processing platform 600a of FIG. 6A may begin by taking an initial count of reusable containers (e.g., the reusable containers 121) to be distributed (602). In these aspects, a user of the example processing platform 600a is a distributor of the reusable containers (e.g., a sport stadium, a school, a college or university, a convention hall, a hotel, etc.) and not an individual.

A scanner (e.g., the scanning device 111) may then scan a unique container identifier (e.g., the unique container identifier 122) of a reusable container (604). In some aspects, the scanner may transmit the unique container identifier and/or an electronic profile associated with the user to an application server (e.g., the server(s) 101). In some aspects, the electronic profile may include (i) a phone number of the user, an email address of the user, an ID of the user, and/or an account of the user and (ii) banking information of the user.

In some aspects, the example processing platform 600a may begin with block 604. In these aspects, the user is an individual and not the distributor. Also in these aspects, the unique container identifier may be scanned by either the individual user or the distributor.

A client device of the user (e.g., the scanning device 111) may then receive a notification containing a perishable, one-time code from the application server (606). The notification may be (i) a text message, (ii) an e-mail, and/or (iii) a push notification from a digital application. In some aspects, the application server transmits the perishable, one-time code to the client device in response to receiving the scan of the unique container identifier.

The perishable, one-time code may then be transmitted back to the application server over a communication network (e.g., the one or more communication networks 110) via a client device (608). In the aspects where the perishable, one-time code is sent to a client device of an individual user, the individual user may transmit the perishable, one-time code to the application server directly via the client device of the individual user. Alternatively, in some aspects, the individual user may first transmit the perishable, one-time code to the distributor, and then the distributor transmits the perishable, one-time code to the application server via the client device of the distributor. In additional alternative aspects where the perishable, one-time code is sent to a client device of a distributor, the distributor user may first transmit the perishable, one-time code to the individual user, and then the individual user transmits the perishable, one-time code to the application server via the client device of the individual user.

Once the application server receives the perishable, one-time code, the application server may flag the reusable container as checked-out (610).

Upon flagging the reusable container as checked-out, the application server may allocate the unique container identifier to the electronic profile associated with the user (612).

In the aspects where the user is the distributor, blocks 606 and 608 may be skipped. For example, when the distributor of the reusable containers is a baseball stadium, a concession stand may scan the unique container identifier of a reusable container (e.g., 604) and then the reusable container that was scanned is flagged as checked-out (e.g., 610). In these aspects, the application server flags the reusable container as checked-out upon receiving the unique container identifier of the reusable container. Blocks 606 and 608 may be skipped in these aspects because the application server only allocates and/or deallocates the reusable containers to the same electronic profile (e.g., the electronic profile of the distributor).

Once the unique container identifier has been allocated to the electronic profile, the application server may generate a timer of a predetermined time period (e.g., a time limit) (614). In some aspects, the timer may halt when the checked-out reusable container is returned within the time period and the checked-out reusable container may be automatically deallocated when the timer reaches the time limit. In the aspects where the timer has reached the time limit, the reusable container may also be flagged as missing and/or to be replaced. Additionally, the electronic profile that was allocated the unique container identifier associated with the reusable container may be charged at least an amount equal to the replacement costs of the reusable container (e.g., manufacturing and/or shipment costs of the reusable container).

In the aspects where the user is the distributor, the example processing platform 600a may end by taking a subsequent count of reusable containers after the time period (616). By comparing the number of reusable containers before allocation (e.g., the initial count) and the number of reusable containers after allocation (e.g., after the time period had lapsed) the distributor and/or the application server may know the number of reusable containers that were not returned by patrons of the distributor and need to be replaced (e.g., based upon the difference between the initial count the subsequent count).

In the aspects where the user is an individual, the example processing platform 600a may end at block 614.

In some aspects, the example processing platform 600b of FIG. 6B may begin by taking an initial count of reusable containers (e.g., the reusable containers 121) that were to be distributed (e.g., the initial count of block 602 as illustrated in FIG. 6A) (622). In these aspects, a user of the example processing platform 600b is a distributor of the reusable containers (e.g., a sport stadium, a school, a college or university, a convention hall, a hotel, etc.) and not an individual.

In some aspects, a scanner (e.g., the scanning device 111) may scan a unique container identifier (e.g., the unique container identifier 122) of a reusable container (624). The scanner may then transmit the unique container identifier to an application server (e.g., the server(s) 101) (626). In the aspects where the user is an individual, because the reusable container being returned has already been allocated to the electronic profile of the individual user, the application server may not need to make a separate determination regarding which electronic profile to deallocate the unique container identifier. In these aspects, the reusable container may have been returned to the distributor and the scanner may be a client device of the distributor.

Alternatively to blocks 624 and 626, in aspects where the user is an individual, the scanner may scan a unique collection bin identifier of a collection bin of returned reusable containers (628). In some aspects, the unique collection bin identifier may include the same technology as the unique container identifiers described above. The scanner may then transmit the unique collection bin identifier to an application server (e.g., the server(s) 101) (630). In these aspects, the scanner is a client device of the individual user. Similar to blocks 624 and 626, because the client device is tied to the electronic profile of the user, the application server may not need to make a separate determination regarding which electronic profile to deallocate the unique container identifier.

In the aspects where the user is an individual, the example processing platform 600b may begin with either block 624 or 628.

Once the application server receives unique container identifier and/or the unique collection bin identifier, the application server may flag the returned reusable container as checked-in (632). In the aspects where the user has multiple reusable containers checked-out at the same time, the user may also transmit to the application server an indication of which reusable containers are being returned (e.g., via unique container identifier in a mobile application, via a return-all selection in the mobile application, etc.).

Upon flagging the reusable container as checked-in, the application server may deallocate the unique container identifier from the electronic profile associated with the user (632). In some aspects, the application server may also reward the user for returning the reusable container prior to the timer reaching the time limit and/or based on (i) the remainder of the time limit, (ii) the number of previously returned reusable containers, and/or (iii) a number of referrals to use the reusable cups made by the user associated with the electronic profile. For example, the user may be rewarded a free item (e.g., such as a keep-sake/novelty reusable drinking cup), a discount on a future uses of reusable containers, and/or a digital punch on a digital punchcard (for example, the user may be rewarded discounted prices and/or free meals upon a set number of digital punches of the digital punchcard and/or completion of the digital punchcard).

In the aspects where the user is the distributor, the example processing platform 600b may end by taking a subsequent count of reusable containers after the time period (636). By comparing the number of reusable containers before allocation (e.g., the initial count) and the number of reusable containers after allocation (e.g., after the time period had lapsed) the distributor and/or the application server may know the number of reusable containers that were not returned by patrons of the distributor and need to be replaced (e.g., based upon the difference between the initial count the subsequent count).

In the aspects where the user is an individual, the example processing platform 600b may end at block 634.

Alternative implementations of the example processing platform 600a and/or the example processing platform 600b represented by the flowcharts of FIGS. 6A and 6B respectively may include one or more additional, less, and/or alternative elements, processes and/or devices. Additionally, or alternatively, one or more of the blocks of the flowcharts may be combined, divided, re-arranged or omitted. Components represented by the blocks of the diagram are implemented by hardware, software, firmware, and/or any combination of hardware, software and/or firmware.

### Exemplary Graphical User Interfaces

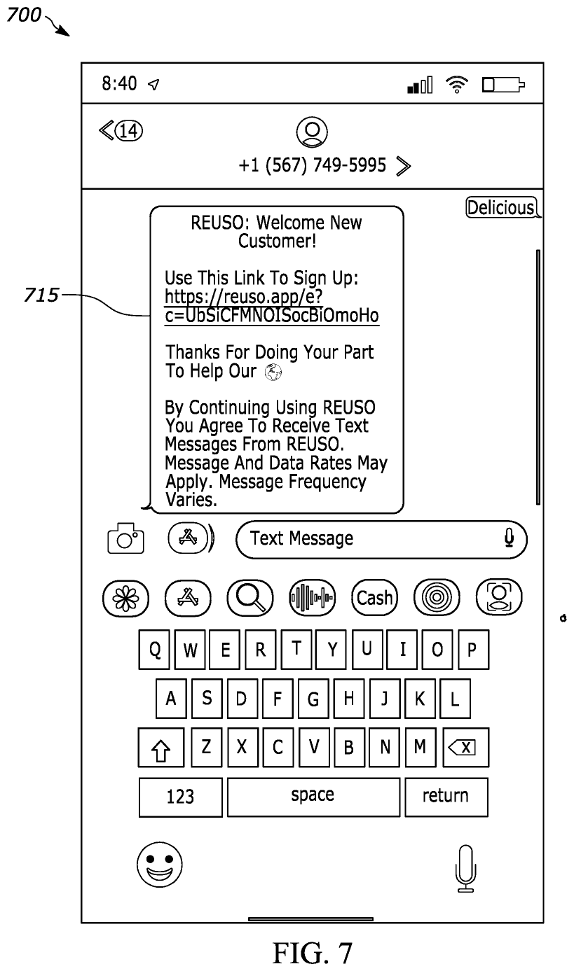

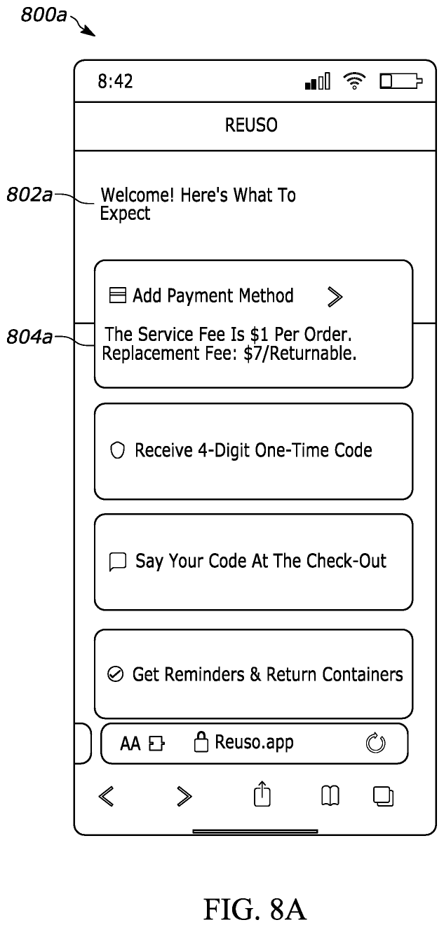

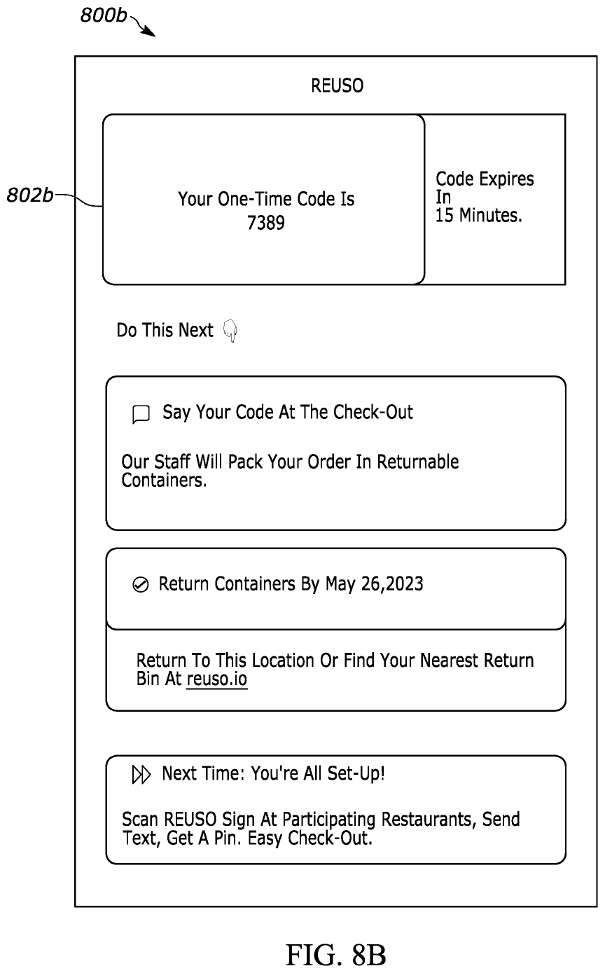

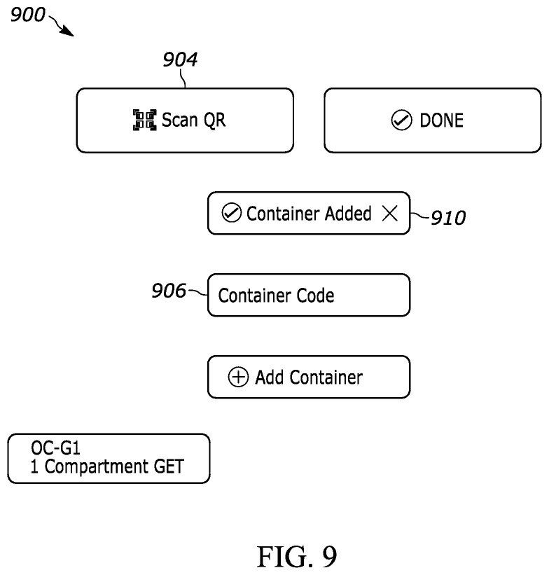

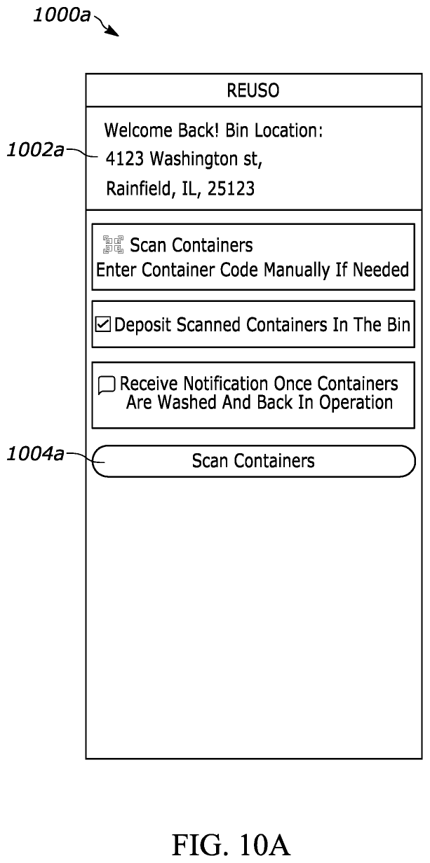

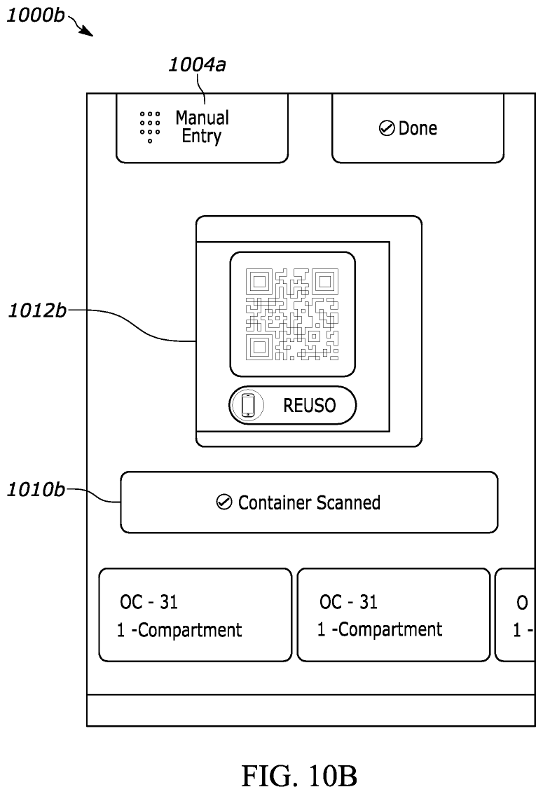

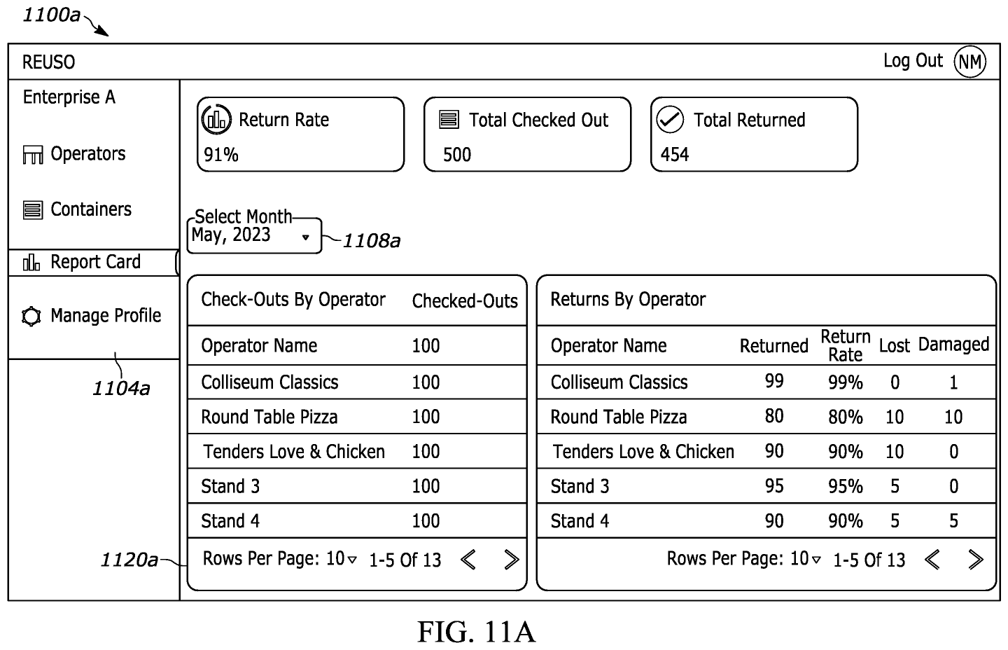

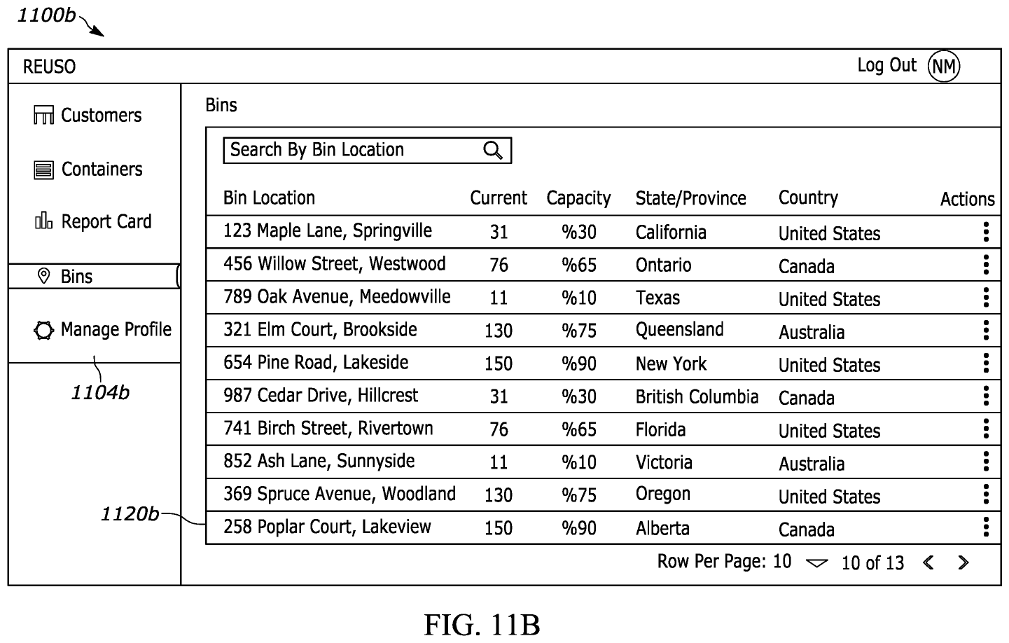

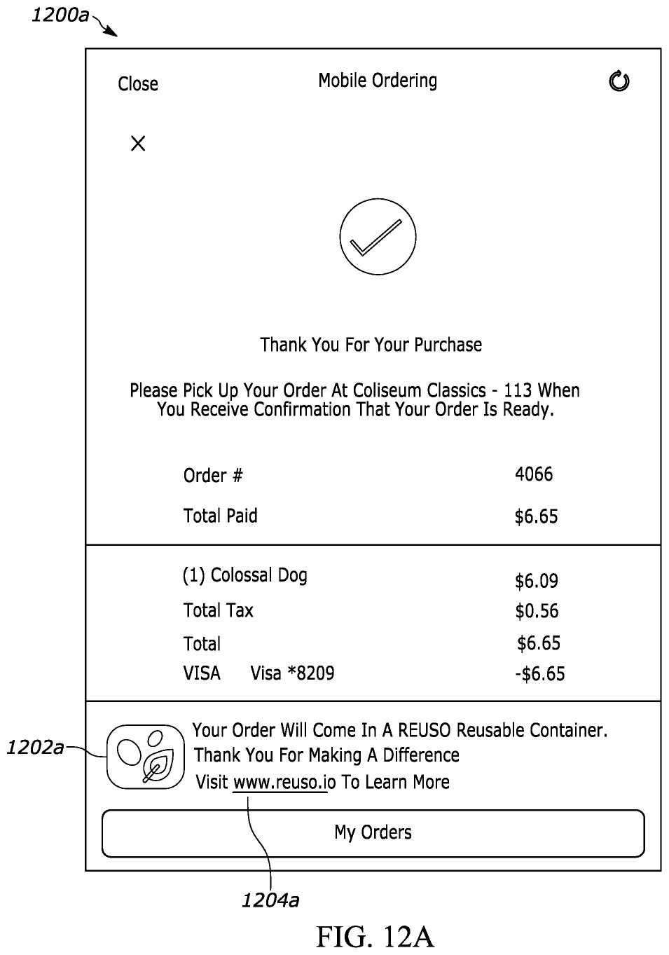

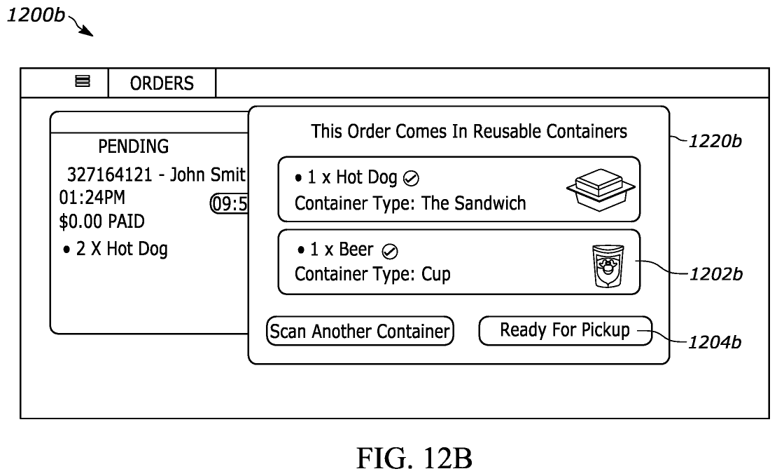

Details of operation of the tagging and tracking reusable packaging are provided with respect to FIGS. 7-12B, which depict example graphical user interfaces (GUIs) that may be displayed on various computing devices (e.g., scanning device(s) 111 of an individual user and/or scanning device(s) 111 of a distributor user of the reusable containers as illustrated in FIG. 1). Particularly, FIG. 7 depicts an example individual facing GUI for user sign up as rendered on a display screen of a computing device, in accordance with various aspects. FIGS. 8A-8B depict example individual facing GUIs for checking-out a reusable container as rendered on a display screen of a computing device, in accordance with various aspects. FIG. 9 depicts an example distributor facing GUI for checking-out a reusable container as rendered on a display screen of a computing device, in accordance with various aspects. FIGS. 10A-10B depict example individual facing GUIs for checking-in a reusable container as rendered on a display screen of a computing device, in accordance with various aspects. FIGS. 11A-11B depict example distributor facing GUIs for checking-in a reusable container as rendered on a display screen of a computing device, in accordance with various aspects. And FIGS. 12A-12B depict example individual facing GUIs for ordering a reusable container as rendered on a display screen of a computing device, in accordance with various aspects.

The GUIs of FIGS. 7-12B may be displayed at the respective computing devices (e.g., individual facing GUIs may be displayed on devices of individual users and distributor facing GUIs may be displayed on of distributor users) based upon execution of non-transitory computer-executable instructions included in one or more digital application (as described herein) stored at these respective computing devices.

FIG. 7 depicts an example sign up GUI 700 via which a user may generate an electronic profile with an application server (e.g., the server(s) 101 as illustrated in FIG. 1). In one aspect, as illustrated by FIG. 7, the sign up GUI 700 may include a short message messaging service (SMS) message 715 (e.g., a text message, an instant message (IM) or direct message (DM) of a platform, etc.) directing the user to interact with link and/or a hyperlink. When interacted with by the user, the user may be directed to a webpage of a website, a web-based application, a location to download a local application on the computing device, and/or the like where the user may be able to enter (i) identity information (e.g., the user's name, address, state ID, etc.), (ii) contact information (e.g., the user's phone number, email address, etc.), and/or (iii) banking and/or credit information. Upon receiving this information, the application server may generate an electronic profile of the user that may include a unique account ID of the user as well as other account information associated with the user based upon the information provided.

FIG. 8A depicts an example individual facing home-page GUI 800a via which a user may navigate to one or more other GUIs. The example individual facing home-page GUI 800a may include non-interactable text and/or images 802a (e.g., the text of “Welcome! Here's what to expect”) as well as interactable elements 804a (e.g., the four interactable buttons that feature the text of “Add Payment Method,” “Receive 4-digit one-time code,” “Say your code at the check-out,” and “Get reminders & return containers,” respectively). The user interacting with any of the interactable elements 804a may cause one or more other GUIs to be displayed on the user's computing device. For example, the user interacting with the Add Payment Method interactable button may cause a payment method GUI (not shown) to be displayed where the user may enter in banking and/or credit information to be saved to the user's electronic profile. As another example, the user interacting with the Receive 4-digit one-time code interactable button and/or the Say your code at the check-out interactable button may cause an individual facing check-out GUI 800b (as illustrated in FIG. 8B) to be displayed. As yet another example, the user interacting with the Get reminders & return containers interactable button may cause an individual facing check-in GUI 1000a (as illustrated in FIG. 10A) to be displayed.

FIG. 8B depicts an example individual facing check-out/check-in GUI 800b via which a user may initiate a check-out or a check-in of one or more reusable containers. The example individual facing check-out/check-in GUI 800b may include non-interactable text and/or images 802b (e.g., the text of “Your one-time code is 7389”). As noted above, once the user interacts with the Receive 4-digit one-time code interactable button and/or the Say your code at the check-out interactable button, the digital application may display the example individual facing check-out/check-in GUI 800b. Once displayed, the application server may generate a random 4-digit decimal number (e.g., the number 7389) for the user to relay to a distributor of one or more reusable containers at check-out. In some aspects, the application server may generate a number of greater or fewer digits and/or of a different number base (e.g., binary, duodecimal, hexadecimal, etc.). Once used, the 4-digit decimal number may not be used again for the checking-out of reusable containers until the application server generates the same 4-digit decimal number at random. In some aspects, the 4-digit decimal number may also have a viability time-limit by which the user and/or the distributor must use it to checkout a reusable container. Once the time-limit has been reached, the application server may flag the 4-digit decimal number as having been used (as if it had been used by the user and/or distributor to checkout a reusable container) thereby preventing it from checking-out a container until the application server generates that same 4-digit decimal number at random. Either the one-time aspect or the time-limit aspect of these numeric codes may make these numeric codes perishable. Upon receiving the 4-digit decimal number, the distributor may enter the 4-digit decimal number in a distributor facing check-out/check-in GUI 900 (as illustrated in FIG. 9).

FIG. 9 depicts an example distributor facing check-out/check-in GUI 900 via which a user who is a distributor may further facilitate a check-out and/or a check-in of one or more reusable containers. The example distributor facing check-out/check-in GUI 900 may include interactable elements 904 (e.g., the three interactable buttons that feature the text of “Scan QR,” “Add Container,” and “Done,” respectively), interactable input elements 906 (e.g., the interactable input text box that features the text of “Container code”) and/or temporary notification elements 910 (e.g., the pop-up notification featuring the text of “Container added”). As noted above, the individual user may relay the 4-digit decimal number to the distributor user. When prompted to enter the 4-digit decimal number (e.g., via an interactable input text box) the example distributor facing check-out/check-in GUI 900 may be displayed. By entering the 4-digit decimal number, the application server knows which electronic profile the application server should allocate and/or deallocate the unique container identifiers (e.g., the unique container identifiers 122 as illustrated in FIG. 1 and/or unique container identifiers 522 as illustrated in FIG. 5) upon check-out and/or check-in, respectively. In some aspects, the distributor may transmit the unique container identifiers of the reusable containers to be checked-out and/or checked-in either manually (e.g., via text input of the input text box) or by scanning the unique container identifiers via an image sensor of the computing device which may be facilitated by a distributor facing scanning GUI (not shown). The scanning GUI may be initiated when the distributor interacts with the Scan QR interactable button. In either instance, once the unique container identifiers of the reusable containers have been entered, the user may interact with the Add Container interactable button to flag these reusable containers as either checked-out and/or checked-in and/or to allocate and/or deallocate these reusable containers to the electronic profile of the individual user. When the distributor is finished checking-out and/or checking-in the reusable containers, the distributor may interact with the Done interactable button to return to another distributor facing GUI.

FIG. 10A depicts an example individual facing check-in GUI 1000a via which a user may initiate a check-in of one or more reusable containers. The example individual facing check-in GUI 1000a may include non-interactable text and/or images 1002a (e.g., the text of “Welcome back! Bin location: 4123 Washington St., Rainfield, IL, 25123”) as well as interactable elements 1004a (e.g., the interactable button that features the text of “Scan Containers,” respectively). The user interacting with any of the interactable elements 1004a may cause one or more other GUIs to be displayed on the user's computing device. For example, the user interacting with the Scan Containers interactable button may cause an individual facing scanning GUI 1000b (as illustrated in FIG. 10B) to be displayed.

FIG. 10B depicts an example individual facing scanning GUI 1000b via which a user may scan a unique container identifier to facilitate a check-out and/or check-in of one or more reusable containers. The example individual facing scanning GUI 1000b may include interactable elements 1004b (e.g., the two interactable buttons that feature the text of “Manual Entry,” and “Done,” respectively), temporary notification elements 1010b (e.g., the pop-up notification featuring the text of “Container scanned”), and/or a captured image display 1012b. Once the user interacts with the Manual Entry interactable button, the digital application may stop displaying the captured image display 1012b and instead present the user with an interactable input element (not shown) (e.g., such as an interactable input text box) for the manual entry of the unique container identifier. However, if the user does not interact with the Manual Entry interactable button, and the user places the unique container identifier within a field of view (FOV) of an image sensor of the computing device (e.g., the one or more image sensors 118), the computing device may automatically capture an image of the unique container identifier, decode the unique container identifier, and/or transmit the unique container identifier and/or decoded data of the unique container identifier to the application server. Upon receiving the unique container identifier, the application server may flag these reusable containers as either checked-out and/or checked-in and/or to allocate and/or deallocate these reusable containers to the electronic profile of the individual user.

FIG. 11A depicts an example distributor facing dashboard GUI 1100a via which a user may view various analytics regarding the distribution of reusable containers as well as navigate to one or more other GUIs. The example distributor facing dashboard GUI 1100a may include interactable elements 1104a (e.g., the 4 interactable buttons that feature the text of “Operators,” “Containers,” “Report Card,” and “Manage Profile,” respectively), interactable selective elements 1108a (e.g., the interactable drop-down selectable menu that features the text “Select month”), and/or interactable windows 1120a that display various analytics regarding the distribution of reusable containers. The user interacting with any of the interactable elements 1104a may cause one or more other GUIs to be displayed on the user's computing device. For example, the user interacting with a “Bins” interactable button (not shown) may cause a distributor facing collection bin window GUI 1100b (as illustrated in FIG. 11B) to be displayed.

FIG. 11B depicts an example distributor facing collection bin window GUI 1100b via which a user may view various analytics regarding collection bins for the collection of reusable containers. The example distributor facing collection bin window GUI 1100b may include interactable elements 1104b (e.g., the 5 interactable buttons that feature the text of “Operators,” “Containers,” “Report Card,” “Bins,” and “Manage Profile,” respectively) and/or interactable windows 1120b that display various analytics regarding collection bins for the collection of reusable containers. The user interacting with any of the interactable elements 1104b may cause one or more other GUIs to be displayed on the user's computing device. For example, the user interacting with the Report Card interactable button may cause a distributor facing dashboard GUI 1100a (as illustrated in FIG. 11A) to be displayed.

FIG. 12A depicts an example individual facing order-summary GUI 1200a of another digital application (e.g., GrubHub, DoorDash, UberEats, MLB ordering, etc.). The example individual facing order-summary GUI 1200a may include non-interactable text and/or images 1202a (e.g., the text of “Your order will come in a REUSO reusable container. Thank you for making a difference. Visit . . . to learn more.”) indicating the user that their order includes checked-out reusable containers allocated to their electronic profile as well as interactable elements 1204a (e.g., a hyperlink featuring a link to a webpage of a website regarding REUSO). The user interacting with the interactable elements 1204a may cause a webpage of a website to be displayed on the user's computing device (e.g., corresponding to a uniform resource locator (URL) of a webpage of a website regarding REUSO).

FIG. 12B depicts a further example individual facing order-summary GUI 1200b of another digital application (e.g., GrubHub, DoorDash, UberEats, MLB ordering, etc.). The example individual facing order-summary GUI 1200a may include an interactable window 1220b featuring non-interactable text and/or images 1202b (e.g., the text of “1×Hot Dog” and “1×Beer” as well as depictions of the reusable containers 421 as illustrated in FIG. 4) indicating the user that their order includes checked-out reusable containers allocated to their electronic profile as well as interactable elements 1204b (e.g., the 2 interactable buttons that feature the text of “Scan Another Contaner” and “Ready for Pickup,” respectively) to check-out and/or allocate more reusable containers to the electronic profile.

The GUIs depicted in FIGS. 7-12B are not limited to the aforementioned and/or illustrated exemplary aspects. For example, while the GUIs depicted in FIGS. 7-8B, 10A-10B, and 12A-12B are formatted for an electronic device in the form of a mobile phone, the GUIs depicted in FIGS. 7-8B, 10A-10B, and 12A-12B may be designed for other devices (e.g., desktop and/or laptop computers, tablets, etc.). Similarly, while the GUIs depicted in FIGS. 9 and 11A-11B are formatted for an electronic device in the form of a desktop and/or laptop computer, GUIs depicted in FIGS. 9 and 11A-11B may be designed for other devices (e.g., mobile phones, tablets, etc.). Additionally, the layout and/or the elements of the GUIs depicted in FIGS. 7-12B may include more or less detail, different language, alternative placement of elements, different ordering, and/or the like. Further, the GUIs depicted in FIGS. 7-12B described herein are not exhaustive, nor should their inclusion be interpreted as a necessary or unnecessary function of the techniques, methods, and systems disclosed herein.

### Additional Implementations

The systems and methods described herein can use RFID chips, QR codes, barcodes, and/or microtransponders (such as p-Chips) to track the reusable containers. The systems and methods can reduce single use plastic containers while providing secure, affordable and transparent digital traceability on a global scale. This begins with the integration of disruptive technical platforms to deliver sustainable solutions and applications that enable simple, secure, and convenient user experiences (transactions) that protect and enhance a brand without detracting from the excitement of the game or the intimacy of the event.

One benefit of using p-Chips include ultrafast (millisecond) read time. Another benefit of using p-Chips include unalterable unique serial identification. Another benefit of using p-Chips include an exceptionally small footprint 590 microns square and 100 microns thick. Another benefit of using p-Chips include how p-Chips can be attached directly to polypropylene and a large variety of thermoplastic materials commonly used in disposable food containers and packaging. Another benefit of using p-Chips include how p-Chips have demonstrated full scale integration with injection molding. Another benefit of using p-Chips include how p-Chips can integrate p-Chips directly into plastic containers by in mold labeling technique. Such in mold labeling techniques allow for tamper proof identification that doubles as brand/logo, and in mold labeling is fully recyclable as there are no paper or adhesives. Another benefit of using p-Chips include how p-Chips are manufactured by globally scaled semiconductor fab processes. Another benefit of using p-Chips include how p-Chips conform to EU standards for direct food contact. Another benefit of using p-Chips include how p-Chip readers are ready and available for POC activities now. Another benefit of using p-Chips include how p-Chip readers can be altered into a wide array of form factors including counter embedded pass overs, array readers, swipe and static stations, and simple data transport to external IT architectures. Another benefit of using p-Chips include the ability of p-Chips to index multiple objects with separate p-Chip. Another benefit of using p-Chips include the ability of the p-Chips to combine p-Chips and indexing with 2D printed codes of all types, RFID and NFC systems.

Some customer facing benefits of the systems and methods may include, by way of non-limiting example, impact calculation to translate reuse data into user metrics and software tools to incentivize returns including deposit, credit card holds, digital punch card; etc.

An AI model can be trained to predict which actions will maximize returns of reusable containers by users. A training model can be based on: location (e.g., users on the West Coast of the US may need fewer actions or activities for returning reusables, Midwest users may need additional instruction to increase use of reusable containers, etc.); deployment scenario (e.g., stadium, campus, airport, café, restaurant, etc.); previous system participation; reward preference to maximize participation and return (free item, BOGO, % off, $ off, etc.); etc.

Some business facing benefits of the systems and methods may be that an AI training model can be used to determine how many containers each vendor needs at each game/each interval throughout the game/when they need next orders. The AI training model can be trained upon data such as: date/time; opposing team (e.g., New York Yankees draw larger crowds in opposing ballparks); standings (e.g., two 1^{st} place teams late in the season draw a bigger crowd); real time data (e.g., sold 2×typical amount of beer in first 3 innings); user data (predictive analysis tracked by ticket ID if venues will allow, no need to capture PII, just dining/beverage habits—model could feed into their ordering systems for food and beverage, e.g., packaging data as a gateway for revenue management); etc.

The disclosed systems and methods can integrate with existing ordering platforms (e.g., GrubHub, MLB ordering, etc.) via API calls to the system. This can track the assignment of a package from Business to Business to Consumer. Granular breakdown can also be provided through the system. For example, the system can tell that an item was sold at an upper deck concession stand, by a given vendor to a specific consumer, and that the reusable container was returned.

The systems and methods can have an API designed to receive an identification of a user to assign a container to, such as a telephone number entry, authentication to existing ordering platform with ability to charge credit card or student ID, credit card or student ID swipe, etc. The order is then sent to back of house (e.g., kitchen) and flagged as a reusable container order.

### Aspects of the Disclosure

The following aspects are provided as examples in accordance with the disclosure herein and are not intended to limit the scope of the disclosure.

1. A system configured to track reusable containers, the system comprising: a plurality of reusable containers, each reusable container comprising a unique container identifier configured to be read by a scanning device; one or more processors communicatively coupled to the scanning device; one or more memories accessible by the one or more processors; and computing instructions stored on the one or more memories that, when executed, cause the one or more processors to: receive the unique container identifier of one of the plurality of reusable containers scanned by the scanning device; allocate the unique container identifier to an electronic profile associated with a user; receive the unique container identifier of the one of the plurality of reusable containers after the unique container identifier has been allocated to the electronic profile associated with the user; and deallocate the unique container identifier from the electronic profile associated with the user.

2. The system of aspect 1, wherein the computing instructions are configured to track the state of the reusable containers.

3. The system of any one or more of the preceding aspects, wherein the computing instructions are configured to compare the total number of times each of the plurality of reusable containers has been assigned to an electronic profile associated with a user and compare the total number of times to a lifespan of each of the plurality of reusable containers.

4. The system of any one or more of the preceding aspects, wherein the computing instructions receive the unique container identifier of one of the plurality of reusable containers from an intermediate ordering platform.

5. The system of any one or more of the preceding aspects, wherein the computing instructions are configured to track a location where the unique container identifier of one of the plurality of reusable containers is scanned.

6. The system of any one or more of the preceding aspects, wherein receipt of the unique container identifier of the one of the plurality of reusable containers after the unique container identifier has been allocated to the electronic profile associated with the user occurs after the one of the plurality of reusable containers has been returned.

7. The system of any one or more of the preceding aspects, wherein the computing instructions are configured to track the number of reusable containers assigned and removed from the electronic profiles of associated users and automatically send an order for additional reusable containers if an inventory of reusable containers is below a predetermined level.

8. The system of any of the preceding claims further comprising: an artificial intelligence (AI) model stored on the one or more memories for outputting a prediction for an event, wherein the AI model is trained on a plurality of training data selected from: dates or times of events, teams or event participants, standings of the teams or event participants, real-time data associated with events, and/or user data of a plurality of users, and wherein the computing instructions, when executed by the one or more processors, cause the one or more processors to: input, into the AI model, one or more of: a date or time of the event, one or more teams or event participants, standings of one or more teams or event participants, real-time data associated with the event, and/or user data; and output, by the AI model, a predicted number of reusable containers expected to be needed for one or more of: the event, one or more intervals during the event, and/or a future time associated with the event or one or more future events.

9. A method for tracking reusable containers, the method comprising: receiving, by one or more processors, a unique container identifier of one of a plurality of reusable containers scanned by a scanning device; allocating, by the one or more processors, the unique container identifier to an electronic profile associated with a user; receiving, by the one or more processors, the unique container identifier of the one of the plurality of reusable containers after the unique container identifier has been allocated to the electronic profile associated with the user; and deallocating, by the one or more processors, the unique container identifier from the electronic profile associated with the user when the one of the plurality of reusable containers has been returned.

10. The method of aspect 9, wherein the user is a distributor of the plurality of reusable containers and the method further comprises: receiving, by the one or more processors, an initial count of the plurality of reusable containers, the initial count being generated before allocating the unique container identifier to the electronic profile; receiving, by the one or more processors, a subsequent count of the plurality of reusable containers, the subsequent count being generated after deallocating the unique container identifier from the electronic profile; and replacing, by the one or more processors, a number of replacement reusable containers, the number based upon a difference between the subsequent count of the plurality of reusable containers and the initial count of the plurality of reusable containers.

11. The method of aspect 9, wherein the user is an individual, allocating the unique container identifier to the electronic profile associated with the user comprises: generating, by the one or more processors, a timer of a predetermined time period, wherein the timer halts when the one of the plurality of reusable containers is returned before the timer reaches the predetermined time period and the one of the plurality of reusable containers is automatically deallocated when the timer reaches the predetermined time period, and prior to allocating the unique container identifier to the electronic profile associated with the user, the method further comprises: transmitting, by the one or more processors, a perishable, one-time code to a client device of the user; and receiving, by the one or more processors from a distributor of the plurality of reusable containers; the perishable, one-time code.

12. The method of aspect 11, the method further comprising: receiving, by the one or more processors, a flag indicating that the timer has halted; and rewarding, by the one or more processors, the electronic profile based upon one or more of (i) a remainder of the predetermined time period, (ii) a number of previously returned reusable containers, or (iii) a number of referred electronic profiles associated with other users, wherein the reward includes one or more of (i) a free item, (ii) a discount on a future use of a reusable container, or (iii) a digital punch on a digital punchcard.

13. The method of aspect 11 or 12, wherein prior to deallocating the unique container identifier from the electronic profile associated with the user, the method further comprises: receiving, by the one or more processors from the client device, unique bin identifier corresponding to a collection bin housing returned reusable containers.

14. The method of aspect 11, 12, or 13, the method further comprising: receiving, by the one or more processors, a flag indicating that the timer has reached the predetermined time period; and either one of: charging, by the one or more processors, the electronic profile a value of the one of the plurality of reusable containers, or deducting, by the one or more processors, one from a current total of reusable containers that can be allocated to the electronic profile.

15. The method of any of the preceding aspects, wherein a distributor of the plurality of reusable containers collects returned reusable containers housed within a plurality of collection bins and the method further comprises: receiving, by the one or more processors, capacity data each collection bin of the plurality of collection bins; determining, by the one or more processors, a collection route of the returned reusable containers based upon (i) a set of geographic locations corresponding to each of the plurality of collection bins and (ii) the capacity data; and transmitting, by the one or more processors to the distributor, the collection route.

16. The method of aspect 15, wherein determining the collection route of the returned reusable containers is further based upon: generating, by the one or more processors, input data comprising (i) current day-of-the-week data, (ii) the set of geographic locations, (iii) the capacity data, and (iv) per mile greenhouse gas emissions generated from collecting the reusable containers from collection bins; and applying, by the one or more processors, a projected-path machine learning model on the input data to generate the collection route, wherein the projected-path machine learning model is trained on a set of prior collection route data, the set of prior collection route data including (i) day-of-the-week data, (ii) set of geographic location data of collection bins visited along each prior collection route, (iii) capacity data of the collection bins visited along each prior collection route, and (iv) per mile greenhouse gas emissions generated from the prior collection route.

17. The method of any of the preceding aspects, the method further comprising: generating, by the one or more processors, a digital representation of the one of the plurality of reusable containers that includes one or more of: (i) the unique container identifier of one of a plurality of reusable containers, (ii) an allocations counter corresponding to a number of prior allocations to electronic profiles, (iii) a lifespan counter corresponding to a number of days since the one of a plurality of reusable containers was first allocated to an electronic profile up until the one of a plurality of reusable containers is replaced, (iv) geographic location data of collection bins the one of the plurality of reusable containers was previously housed in, or (v) date data of when the one of the plurality of reusable containers was previously deallocated.

18. The method of aspect 17, wherein the digital representation of the one of the plurality of reusable containers includes (i) unique container identifiers of the replaced reusable containers, (ii) allocations counters of the replaced reusable containers, and (iii) lifespan counters of the replaced reusable containers, and the method further comprises: applying, by the one or more processors, a replacement prediction machine learning model on the digital representation to predict a replacement time of the one of the plurality of reusable containers, wherein the replacement prediction machine learning model is trained on a training set of digital representations of previously replaced reusable containers, the training set of digital representations including (i) unique container identifiers of the previously replaced reusable containers, (ii) allocations counters of the previously replaced reusable containers, and (iii) lifespan counters of the previously replaced reusable containers.

19. A tangible, non-transitory computer-readable medium storing instructions for tracking reusable containers that when executed by one or more processors cause the one or more processors to: receive, by one or more processors, a unique container identifier of one of a plurality of reusable containers scanned by a scanning device; allocate, by the one or more processors, the unique container identifier to an electronic profile associated with a user; receive, by the one or more processors, the unique container identifier of the one of the plurality of reusable containers after the unique container identifier has been allocated to the electronic profile associated with the user; and deallocate, by the one or more processors, the unique container identifier from the electronic profile associated with the user when the one of the plurality of reusable containers has been returned.

### Additional Aspects of the Disclosure

The following aspects are provided as examples in accordance with the disclosure herein and are not intended to limit the scope of the disclosure.

1. A system configured to track reusable containers, the system comprising: a plurality of reusable containers, each reusable container comprising a unique container identifier configured to be read by a scanning device; one or more processors communicatively coupled to the scanning device; one or more memories accessible by the one or more processors; and computing instructions stored on the one or more memories that, when executed, cause the one or more processors to: receive the unique container identifier of one of the plurality of reusable containers scanned by the scanning device; allocate the unique container identifier to an electronic profile associated with a user; receive the unique container identifier of the one of the plurality of reusable containers after the unique container identifier has been allocated to the electronic profile associated with the user; and deallocate the unique container identifier from the electronic profile associated with the user.

2. The system of aspect 1, wherein the reusable containers comprises at least one of: beverage containers, food containers, and/or product containers.

3. The system of any one or more of the preceding aspects, wherein the unique container identifier is contained in at least one of: a radio frequency identification (RFID) chip, a quick response (QR) code, a barcode, and/or a microtransponder.

4. The system of aspect 3, wherein the microtransponder is a p-Chip.

5. The system of aspect 3, wherein the RFID chips are attached to the reusable containers.

6. The system of aspect 5, wherein the RFID chips are molded into the reusable containers.

7. The system of aspect 3, wherein the QR codes are: printed on a surface of the reusable containers, printed on a label attached to the reusable container, or molded into the surface of the reusable containers.

8. The system of aspect 3 wherein the barcodes are: printed on a surface of the reusable container, printed on a label attached to the reusable container, or molded into the surface of the reusable containers.

9. The system of any one or more of the preceding aspects, wherein the scanning device comprises at least one of: an RFID reader, a QR code reader, a barcode reader, and/or a p-Chip reader.

10. The system of any one or more of the preceding aspects, wherein the unique container identifiers are assigned to a platform user.

11. The system of any one or more of the preceding aspects, wherein assigning the unique container identifier to the electronic profile associated with the user comprises associating the container identifier with one or more of: a phone number of the user, a credit card number of the user, and/or an application (app) installed on a device of the use.

12. The system of any of the preceding claims, wherein the computing instructions are configured to track the state of the reusable containers.

13. The system of any one or more of the preceding aspects, wherein the computing instructions are configured to compare the total number of times each of the plurality of reusable containers has been assigned to an electronic profile associated with a user and compare the total number of times to a lifespan of each of the plurality of reusable containers.

14. The system of any one or more of the preceding aspects, wherein the computing instructions receive the unique container identifier of one of the plurality of reusable containers from an intermediate ordering platform.

15. The system of any one or more of the preceding aspects, wherein the computing instructions are configured to track a location where the unique container identifier of one of the plurality of reusable containers is scanned.

16. The system of any one or more of the preceding aspects, wherein the computing instructions are configured to determine one or more of: electricity saved, material wasted saved, and/or CO₂ saved, based on the number of unique container identifiers assigned and removed from the electronic profiles of associated users.

17. The system of any one or more of the preceding aspects, wherein receipt of the unique container identifier of the one of the plurality of reusable containers after the unique container identifier has been allocated to the electronic profile associated with the user occurs after the one of the plurality of reusable containers has been returned.

18. The system of any one or more of the preceding aspects, wherein the computing instructions are configured to charge an associated user if one of the plurality of reusable containers assigned to the electronic profile of the user is not returned.

19. The system of any one or more of the preceding aspects, wherein the computing instructions are configured to provide a reward to the user after one of the plurality of reusable containers assigned to the electronic profile of the user is returned.

20. The system of any one or more of the preceding aspects, wherein the computing instructions are configured to track the number of reusable containers assigned and removed from the electronic profiles of associated users and automatically send an order for additional reusable containers if an inventory of reusable containers is below a predetermined level.

21. The system of any of the preceding claims further comprising: an artificial intelligence (AI) model stored on the one or more memories for outputting a prediction for an event, and wherein the computing instructions, when executed by the one or more processors, cause the one or more processors to: input, into the AI model, one or more of: a date or time of the event, one or more teams or event participants, standings of one or more teams or event participants, real-time data associated with the event, and/or user data; and output, by the AI model, a predicted number of reusable containers expected to be needed for one or more of: the event, one or more intervals during the event, and/or a future time associated with the event or one or more future events.

22. A method for tracking reusable containers, the method comprising: receiving, by one or more processors, a unique container identifier of one of a plurality of reusable containers scanned by a scanning device; allocating, by the one or more processors, the unique container identifier to an electronic profile associated with a user; receiving, by the one or more processors, the unique container identifier of the one of the plurality of reusable containers after the unique container identifier has been allocated to the electronic profile associated with the user; and deallocating, by the one or more processors, the unique container identifier from the electronic profile associated with the user when the one of the plurality of reusable containers has been returned.

23. The method of aspect 22, wherein the user is a distributor of the plurality of reusable containers and the method further comprises: receiving, by the one or more processors, an initial count of the plurality of reusable containers, the initial count being generated before allocating the unique container identifier to the electronic profile; receiving, by the one or more processors, a subsequent count of the plurality of reusable containers, the subsequent count being generated after deallocating the unique container identifier from the electronic profile; and replacing, by the one or more processors, a number of replacement reusable containers, the number based upon a difference between the subsequent count of the plurality of reusable containers and the initial count of the plurality of reusable containers.

24. The method of aspect 22, wherein the user is an individual, allocating the unique container identifier to the electronic profile associated with the user comprises: generating, by the one or more processors, a timer of a predetermined time period, wherein the timer halts when the one of the plurality of reusable containers is returned before the timer reaches the predetermined time period and the one of the plurality of reusable containers is automatically deallocated when the timer reaches the predetermined time period, and prior to allocating the unique container identifier to the electronic profile associated with the user, the method further comprises: transmitting, by the one or more processors, a perishable, one-time code to a client device of the user; and receiving, by the one or more processors from a distributor of the plurality of reusable containers; the perishable, one-time code.

25. The method of aspect 24, the method further comprising: receiving, by the one or more processors, a flag indicating that the timer has halted; and rewarding, by the one or more processors, the electronic profile based upon one or more of (i) a remainder of the predetermined time period, (ii) a number of previously returned reusable containers, or (iii) a number of referred electronic profiles associated with other users, wherein the reward includes one or more of (i) a free item, (ii) a discount on a future use of a reusable container, or (iii) a digital punch on a digital punchcard.

26. The method of aspect 24 or 25, wherein prior to deallocating the unique container identifier from the electronic profile associated with the user, the method further comprises: receiving, by the one or more processors from the client device, unique bin identifier corresponding to a collection bin housing returned reusable containers.

27. The method of aspect 24, 25, or 26, the method further comprising: receiving, by the one or more processors, a flag indicating that the timer has reached the predetermined time period; and either one of: charging, by the one or more processors, the electronic profile a value of the one of the plurality of reusable containers, or deducting, by the one or more processors, one from a current total of reusable containers that can be allocated to the electronic profile.

28. The method of any of the preceding aspects, wherein a distributor of the plurality of reusable containers collects returned reusable containers housed within a plurality of collection bins and the method further comprises: receiving, by the one or more processors, capacity data each collection bin of the plurality of collection bins; determining, by the one or more processors, a collection route of the returned reusable containers based upon (i) a set of geographic locations corresponding to each of the plurality of collection bins and (ii) the capacity data; and transmitting, by the one or more processors to the distributor, the collection route.

29. The method of aspect 28, wherein determining the collection route of the returned reusable containers is further based upon: generating, by the one or more processors, input data comprising (i) current day-of-the-week data, (ii) the set of geographic locations, (iii) the capacity data, and (iv) per mile greenhouse gas emissions generated from collecting the reusable containers from collection bins; and applying, by the one or more processors, a projected-path machine learning model on the input data to generate the collection route, wherein the projected-path machine learning model is trained on a set of prior collection route data, the set of prior collection route data including (i) day-of-the-week data, (ii) set of geographic location data of collection bins visited along each prior collection route, (iii) capacity data of the collection bins visited along each prior collection route, and (iv) per mile greenhouse gas emissions generated from the prior collection route.

30. The method of any of the preceding aspects, the method further comprising: generating, by the one or more processors, a digital representation of the one of the plurality of reusable containers that includes one or more of: (i) the unique container identifier of one of a plurality of reusable containers, (ii) an allocations counter corresponding to a number of prior allocations to electronic profiles, (iii) a lifespan counter corresponding to a number of days since the one of a plurality of reusable containers was first allocated to an electronic profile up until the one of a plurality of reusable containers is replaced, (iv) geographic location data of collection bins the one of the plurality of reusable containers was previously housed in, or (v) date data of when the one of the plurality of reusable containers was previously deallocated.

31. The method of aspect 30, wherein the digital representation of the one of the plurality of reusable containers includes (i) unique container identifiers of the replaced reusable containers, (ii) allocations counters of the replaced reusable containers, and (iii) lifespan counters of the replaced reusable containers, and the method further comprises: applying, by the one or more processors, a replacement prediction machine learning model on the digital representation to predict a replacement time of the one of the plurality of reusable containers, wherein the replacement prediction machine learning model is trained on a training set of digital representations of previously replaced reusable containers, the training set of digital representations including (i) unique container identifiers of the previously replaced reusable containers, (ii) allocations counters of the previously replaced reusable containers, and (iii) lifespan counters of the previously replaced reusable containers.

32. The method of any of the preceding aspects, wherein: (i) the reusable containers are made out of a recyclable material and comprise at least one of: beverage containers, food containers, or product containers, (ii) the unique container identifier is contained in at least one of: a radio frequency identification (RFID) chip, a quick response (QR) code, a barcode, or a microtransponder, and (iii) the scanning device comprises at least one of: an RFID reader, a QR code reader, a barcode reader, or a p-Chip reader.

33. The method of any of the preceding aspects, wherein the electronic profile includes (i) one or more of: a phone number of the user, an email address of the user, an ID of the user, or an account of the user and (ii) banking information of the user.

34. A tangible, non-transitory computer-readable medium storing instructions for tracking reusable containers that when executed by one or more processors cause the one or more processors to: receive, by one or more processors, a unique container identifier of one of a plurality of reusable containers scanned by a scanning device; allocate, by the one or more processors, the unique container identifier to an electronic profile associated with a user; receive, by the one or more processors, the unique container identifier of the one of the plurality of reusable containers after the unique container identifier has been allocated to the electronic profile associated with the user; and deallocate, by the one or more processors, the unique container identifier from the electronic profile associated with the user when the one of the plurality of reusable containers has been returned.

### ADDITIONAL CONSIDERATIONS

Although the disclosure herein sets forth a detailed description of numerous different aspects, it should be understood that the legal scope of the description is defined by the words of the claims set forth at the end of this patent and equivalents. The detailed description is to be construed as exemplary only and does not describe every possible aspect since describing every possible aspect would be impractical. Numerous alternative aspects may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location, while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other aspects, the one or more processors or processor-implemented modules may be distributed across a number of geographic locations.

This detailed description is to be construed as exemplary only and does not describe every possible aspect, as describing every possible aspect would be impractical, if not impossible. A person of ordinary skill in the art may implement numerous alternate aspects, using either current technology or technology developed after the filing date of this application.

Those of ordinary skill in the art will recognize that a wide variety of modifications, alterations, and combinations can be made with respect to the above-described aspects without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. A system configured to track reusable containers, the system comprising:
a plurality of reusable containers, each reusable container comprising a unique container identifier configured to be read by a scanning device;
one or more processors communicatively coupled to the scanning device;
one or more memories accessible by the one or more processors; and
computing instructions stored on the one or more memories that, when executed, cause the one or more processors to:
receive the unique container identifier of one of the plurality of reusable containers scanned by the scanning device;
allocate the unique container identifier to an electronic profile associated with a user;
receive the unique container identifier of the one of the plurality of reusable containers after the unique container identifier has been allocated to the electronic profile associated with the user; and
deallocate the unique container identifier from the electronic profile associated with the user.

2. The system of claim 1, wherein the computing instructions are configured to track a state of the reusable containers.

3. The system of claim 1, wherein the computing instructions are configured to compare a total number of times each of the plurality of reusable containers has been assigned to an electronic profile associated with a user and compare the total number of times to a lifespan of each of the plurality of reusable containers.

4. The system of claim 1, wherein the computing instructions receive the unique container identifier of one of the plurality of reusable containers from an intermediate ordering platform.

5. The system of claim 1, wherein the computing instructions are configured to track a location where the unique container identifier of one of the plurality of reusable containers is scanned.

6. The system of claim 1, wherein receipt of the unique container identifier of the one of the plurality of reusable containers after the unique container identifier has been allocated to the electronic profile associated with the user occurs after the one of the plurality of reusable containers has been returned.

7. The system of claim 1, wherein the computing instructions are configured to track a number of reusable containers assigned and removed from the electronic profiles of associated users and automatically send an order for additional reusable containers if an inventory of reusable containers is below a predetermined level.

8. The system of claim 1 further comprising:
an artificial intelligence (AI) model stored on the one or more memories for outputting a prediction for an event, wherein the AI model is trained on a plurality of training data selected from: dates or times of events, teams or event participants, standings of the teams or event participants, real-time data associated with events, and/or user data of a plurality of users, and
wherein the computing instructions, when executed by the one or more processors, cause the one or more processors to:
input, into the AI model, one or more of: a date or time of the event, one or more teams or event participants, standings of one or more teams or event participants, real-time data associated with the event, and/or user data; and
output, by the AI model, a predicted number of reusable containers expected to be needed for one or more of: the event, one or more intervals during the event, and/or a future time associated with the event or one or more future events.

9. A method for tracking reusable containers, the method comprising:
receiving, by one or more processors, a unique container identifier of one of a plurality of reusable containers scanned by a scanning device;
allocating, by the one or more processors, the unique container identifier to an electronic profile associated with a user;
receiving, by the one or more processors, the unique container identifier of the one of the plurality of reusable containers after the unique container identifier has been allocated to the electronic profile associated with the user; and
deallocating, by the one or more processors, the unique container identifier from the electronic profile associated with the user when the one of the plurality of reusable containers has been returned.

10. The method of claim 9, wherein the user is a distributor of the plurality of reusable containers, and the method further comprises:
receiving, by the one or more processors, an initial count of the plurality of reusable containers, the initial count being generated before allocating the unique container identifier to the electronic profile;
receiving, by the one or more processors, a subsequent count of the plurality of reusable containers, the subsequent count being generated after deallocating the unique container identifier from the electronic profile; and
replacing, by the one or more processors, a number of replacement reusable containers, the number based upon a difference between the subsequent count of the plurality of reusable containers and the initial count of the plurality of reusable containers.

11. The method of claim 9, wherein:
the user is an individual,
allocating the unique container identifier to the electronic profile associated with the user comprises:
generating, by the one or more processors, a timer of a predetermined time period, wherein the timer halts when the one of the plurality of reusable containers is returned before the timer reaches the predetermined time period and the one of the plurality of reusable containers is automatically deallocated when the timer reaches the predetermined time period, and
prior to allocating the unique container identifier to the electronic profile associated with the user, the method further comprises:
transmitting, by the one or more processors, a perishable, one-time code to a client device of the user; and
receiving, by the one or more processors from a distributor of the plurality of reusable containers; the perishable, one-time code.

12. The method of claim 11, the method further comprising:
receiving, by the one or more processors, a flag indicating that the timer has halted; and
rewarding, by the one or more processors, the electronic profile based upon one or more of (i) a remainder of the predetermined time period, (ii) a number of previously returned reusable containers, or (iii) a number of referred electronic profiles associated with other users, wherein the reward includes one or more of (i) a free item, (ii) a discount on a future use of a reusable container, or (iii) a digital punch on a digital punchcard.

13. The method of claim 12, wherein prior to deallocating the unique container identifier from the electronic profile associated with the user, the method further comprises:
receiving, by the one or more processors from the client device, unique bin identifier corresponding to a collection bin housing returned reusable containers.

14. The method of claim 11, the method further comprising:
receiving, by the one or more processors, a flag indicating that the timer has reached the predetermined time period; and
either one of:
charging, by the one or more processors, the electronic profile a value of the one of the plurality of reusable containers, or
deducting, by the one or more processors, one from a current total of reusable containers that can be allocated to the electronic profile.

15. The method of claim 9, wherein a distributor of the plurality of reusable containers collects returned reusable containers housed within a plurality of collection bins and the method further comprises:
receiving, by the one or more processors, capacity data each collection bin of the plurality of collection bins;
determining, by the one or more processors, a collection route of the returned reusable containers based upon (i) a set of geographic locations corresponding to each of the plurality of collection bins and (ii) the capacity data; and
transmitting, by the one or more processors to the distributor, the collection route.

16. The method of claim 15, wherein determining the collection route of the returned reusable containers is further based upon:
generating, by the one or more processors, input data comprising (i) current day-of-the-week data, (ii) the set of geographic locations, (iii) the capacity data, and (iv) per mile greenhouse gas emissions generated from collecting the reusable containers from collection bins; and
applying, by the one or more processors, a projected-path machine learning model on the input data to generate the collection route, wherein the projected-path machine learning model is trained on a set of prior collection route data, the set of prior collection route data including (i) day-of-the-week data, (ii) set of geographic location data of collection bins visited along each prior collection route, (iii) capacity data of the collection bins visited along each prior collection route, and (iv) per mile greenhouse gas emissions generated from the prior collection route.

17. The method of claim 9, the method further comprising:
generating, by the one or more processors, a digital representation of the one of the plurality of reusable containers that includes one or more of: (i) the unique container identifier of one of a plurality of reusable containers, (ii) an allocations counter corresponding to a number of prior allocations to electronic profiles, (iii) a lifespan counter corresponding to a number of days since the one of a plurality of reusable containers was first allocated to an electronic profile up until the one of a plurality of reusable containers is replaced, (iv) geographic location data of collection bins the one of the plurality of reusable containers was previously housed in, or (v) date data of when the one of the plurality of reusable containers was previously deallocated.

18. The method of claim 17, wherein the digital representation of the one of the plurality of reusable containers includes (i) unique container identifiers of the replaced reusable containers, (ii) allocations counters of the replaced reusable containers, and (iii) lifespan counters of the replaced reusable containers, and the method further comprises:
applying, by the one or more processors, a replacement prediction machine learning model on the digital representation to predict a replacement time of the one of the plurality of reusable containers, wherein the replacement prediction machine learning model is trained on a training set of digital representations of previously replaced reusable containers, the training set of digital representations including (i) unique container identifiers of the previously replaced reusable containers, (ii) allocations counters of the previously replaced reusable containers, and (iii) lifespan counters of the previously replaced reusable containers.

19. A tangible, non-transitory computer-readable medium storing instructions for tracking reusable containers that when executed by one or more processors cause the one or more processors to:
receive, by one or more processors, a unique container identifier of one of a plurality of reusable containers scanned by a scanning device;
allocate, by the one or more processors, the unique container identifier to an electronic profile associated with a user;
receive, by the one or more processors, the unique container identifier of the one of the plurality of reusable containers after the unique container identifier has been allocated to the electronic profile associated with the user; and
deallocate, by the one or more processors, the unique container identifier from the electronic profile associated with the user when the one of the plurality of reusable containers has been returned.
